(19) United States
(12) Patent Application Publication
(10) Pub. No.: US 2017/0234837 A1
(43) Pub. Date: Aug. 17, 2017

(54) ACOUSTIC APPARATUS AND METHOD

(71) Applicant: RENISHAW PLC, Wotton-under-Edge, Gloucestershire (GB)

(72) Inventors: Liam David HALL, East Lothian (GB); Richard George DEWAR, Peebles (GB)

(73) Assignee: RENISHAW PLC, Wotton-under-Edge, Gloucestershire (GB)

(21) Appl. No.: 15/518,705

(22) PCT Filed: Oct. 26, 2015
(86) PCT No.: PCT/EP2015/074735

§ 371 Date: Apr. 12, 2017

(30) Foreign Application Priority Data
Oct. 24, 2014 (EP) 14190299.9

(51) Int. Cl. G01N 29/24; G01N 29/07; G01N 29/22; G01N 29/04

(52) U.S. Cl. CPC G01N 29/2431; G01N 29/045; G01N 29/07; G01N 29/226; G01N 29/2475; G01N 2291/103

(57) ABSTRACT

An acoustic device for inspection of an object. The device includes an ultrasonic source including a snap-through buckling actuator. The device may be used for non-destructive testing of objects. The device may be carried by a platform, such as a coordinate measuring machine, to allow inspection of objects or it may be embedded within an object for life cycle monitoring purposes.

The present invention relates to acoustic apparatus for inspection of an object, and in particular to an acoustic device that comprise a snap-through buckling actuator for generating ultrasound. Apparatus and objects incorporating the acoustic device, and various methods for using the device for non-destructive inspection (NDI) applications and the like, are also described.

A variety of non-destructive inspection (NDI) techniques exist for evaluating the properties of an object without causing any damage to that object. These include various techniques that use ultrasound to inspect objects. For example, it is known to perform NDI, also termed non-destructive testing (NDT), of objects using pulse-echo mode ultrasound systems. Such systems typically include a transceiver, comprising a piezo-electric or magneto-restrictive transducer element, that is acoustically coupled to an object to be inspected. An ultrasound pulse generated by the transceiver passes into the object. Reflections of the pulse from within the object are detected and analysed. Such pulse-echo mode ultrasound systems are typically complex, expensive and almost always require a couplant gel or liquid to provide sufficiently good acoustic coupling with the object being inspected.

Another known NDI technique uses an acoustic system comprising a plurality of receivers placed at various positions on the object being inspected. The receivers detect any acoustic signals generated by acoustic events occurring within the object (e.g. cracking, de-lamination etc). Such Acoustic Emissions (AE) systems are typically calibrated by passing an acoustic pulse through the object. The acoustic emission source used in such systems for calibration purposes is typically a pencil-lead breakage based system, which is commonly termed a Hsu-Nielsen source. In such a system, the pencil lead is pressed firmly against the object under investigation until the lead breaks. Loading the lead into the surface in this manner causes the surface to deform and at the moment of lead breakage the accumulated stress is suddenly released. This causes a microscopic displacement of the surface and results in an acoustic wave that propagates into the structure. The lead breakage and replacement process is, however, unpredictable and inconvenient.

In the field of acoustic distance (pulse-echo) measurement, an ultrasound source in the form of a snap-though shell has been previously proposed by M Cichos (Ultrasonics, IPC Science and technology Press ltd, Guildford. Vol. 5, no. 4, pages 243-245, 1 Oct. 1967). In particular, this is described as being an alternative to normal electroacoustic transducers that were found to be ruined by dust and heat.

According to first aspect of the present invention, there is provided an acoustic device for inspecting an object, the device comprising an ultrasonic source comprising a snap-through buckling actuator for generating ultrasound for coupling into the object to be inspected.

The present invention thus provides an acoustic device for use when inspecting an object, the device comprising an ultrasonic source comprising a snap-through buckling actuator. In other words, an acoustic device is provided that is used to generate ultrasound for coupling into an object (e.g. a solid object) to be inspected. The device may be used for any object inspection purpose; for example, the device may be used for non-destructive inspection, in-service or life-cycle monitoring or AE calibration applications. The acoustic device comprises an ultrasonic source that includes a snap-through buckling actuator. The snap-through buckling actuator (which may also be termed a “snap-through” actuator) stores potential energy as it is deformed, for example as it is pressed into engagement with a surface, and suddenly releases that energy when the buckling effect occurs (i.e. the buckling causes a “snap-through” that releases the stored energy). This sudden energy release has been found to generate wideband, controllable and structured acoustic emissions that can be readily coupled into parts to be inspected. In particular, acoustic waveforms are generated principally within the low ultrasonic band (e.g. 0.1-2 MHz) and will readily propagate through the bulk or across the surface of an inspection part. The acoustic waveforms generated by the actuator also have highly repeatable signal phase and amplitude properties and, as described below, may be detected by one or more acoustic sensors appropriately coupled to the inspection part. The device may thus be used for defect detection, acoustic imaging of parts etc.

The acoustic device of the present invention has a number of advantages over known ultrasound sources. Unlike the Hsu-Neilsen lead break source, the device of the present invention is inherently resettable and produces highly repeatable signal phase and amplitude waveforms. In other words, the snap-through buckling actuator can be repeatedly activated, each activation generating an ultrasound pulse for coupling into an object to be inspected. This is an improvement over the random effects of shearing lead that are inherent to the Hsu-Nielsen source. Furthermore, the present invention allows ultrasound to be transmitted into the inspection object at a very small aperture point which obviates the need to apply a liquid couplant between the actuator and the inspection surface. This is an advantage over conventional piezo-electric based transducers that typically include a relatively large contact plate and require couplant liquids or gels to be applied in order to ensure sufficient ultrasound is coupled into the object. The device of the present invention can also be passively operated (i.e. it does not need an electrical power source), which has numerous advantages over actively driven piezo-electric based system that require a power source and complex pulse generation electronics.

Although an ultrasound device comprising a snap-though shell has been proposed previously by Cichos as mentioned above, this is described as a replacement for an electrical transducer that can be affected by dust and heat. The Cichos device is arranged to emit ultrasound pulses that are transmitted through a gas (e.g. air) and reflected from a surface. The reflected ultrasound (echo) is used to measure the distance of the surface from the ultrasound emitter/receiver. The ultrasound generated in the Cichos device is not coupled (directly or indirectly) into an object and is not used for any kind of internal inspection of an object.

As outlined above, the device of the present invention is configured to couple ultrasound into the object to be inspected. The device may be directly coupled to the object. For example, a part of the device may be placed into direct physical contact with the object. This direct physical contact then provides an acoustic connection between the device and the object. Alternatively, the device may be indirectly coupled to the object via an intermediate structure of some type that guides ultrasound from the device into the object. In both cases, the acoustic connection is provided by placing the snap-through buckling actuator into acoustic contact with the object via a physical connection. The exact form of the acoustic connection may vary, depending on the application. Advantageously, the device comprises at least one tip for contacting an object to be inspected. The device may comprise a plurality of tips. Advantageously, the device comprises a single tip. The at least one tip preferably forms a Hertzian contact with the inspection surface. The at least one tip conveniently has a small aperture. The at least one tip preferably has a sharp distal end. The at least one tip may be partly spherical. The at least one tip may be formed from a hard material, such as ruby or zirconia. Preferably, the at least one tip is formed (e.g. machined) from the material forming the snap-though buckling actuator. The at least one tip may be arranged to penetrate any layers (e.g. of rust, paint etc) on the surface of the object being inspected. The tip may also provide a small amount of lateral movement across the inspection surface prior to, and/or during, actuation of the snap-though buckling actuator. Such lateral movement may help penetrate through the rougher surface asperity micro-structure and reduce variability in transmitted signal amplitude thereby further reducing the need for a liquid or gel coupling layer. The device of the present invention is thus particularly suited for use on rougher inspection surfaces.

For embedded devices, the tip may be permanently affixed (e.g. welded) to the object. The device may be used to inspect any suitable object. In particular, the object may have internal or surface features that can be inspected using ultrasound that is coupled into the object. Advantageously, the object is a solid object (e.g. metal, ceramic, concrete etc). The solid object may comprise any of the materials described in more detail below.

Advantageously, the device comprises a waveguide for guiding energy released by the snap-through buckling actuator to said at least one tip. In particular, a waveguide is preferably arranged so that the ensemble stress wave generated by triggering of the snap-through buckling actuator propagates efficiently to the tip. In other words, the waveguide may be shaped to focus energy released by the snap-through action to the tip. The ultrasonic source may comprise such a waveguide. For example, the snap-through buckling actuator may conveniently be formed integrally with a suitable waveguide. As explained in more detail below, variation in the design of the snap-through buckling actuator, waveguide and/or tip allow the device to be configured to excite different wave modes for different sensing applications.

Preferably, the snap-through buckling actuator comprises an elastically deformable beam. The beam is preferably resilient and/or flexible. The flexible beam may be formed from any suitable material, such as plastic, metal etc. Advantageously, the flexible beam comprises a metallic (e.g. stainless steel, titanium or aluminium) plate. The metallic plate is preferably thin. For example, the metallic plate may be less than 5 mm, less than 3 mm or less than 1 mm thick.

The elastically deformable beam preferably also includes one or more features that provide a snap-through bucking action when subjected to a mechanical load. Any suitable feature or features may be provided to implement the snap-through buckling effect. A dome shaped feature and/or a dimple shaped feature may be conveniently used. For example, a dome may be formed in a planar metallic plate. Such a dome may be formed by providing a plurality of concentric indentations in the plate. These indentations may be formed using a stamping or chemical etching process.

The snap-through buckling actuator may be multi-stable. For example, it may be bi-stable or stable in three or more different states. Advantageously, the snap-through buckling actuator is mono-stable. In other words, the snap-through buckling actuator preferably always returns to a single mechanically stable state in the absence of an applied deformation force. In the preferred embodiment described above, the elastically deformable, flexible beam is preferably mono-stable and thus returns to its stable state when the mechanical load is removed. This mono-stability may be attained using the dome structure described above. It should also be noted here that a mono-stable snap-through buckling actuator generates an ultra-sound pulse when buckling due to application of a loading force and also when returning to its stable state when the loading force is reduce or removed (i.e. snapping back). Either or both of these ultrasound pulses may be used for object inspection purpose.

Advantageous, the snap-through buckling actuator comprises a base member for holding at least a part of the elastically deformable, flexible beam. In particular, one or both ends of the elastically deformable, flexible beam may be secured to a rigid base member. The base member may be clamped to both sides of the flexible beam, or it may be secured to a single side of the flexible beam. The base member may be shaped to fully surround the one or more features (e.g. the dome) that provide the snap-through bucking action. Advantageously, the base member may be shaped to partially surround the one or more features (e.g. the dome) that provide the snap-through bucking action. The base member has the effect of restricting the linear flexural strain or displacement of the flexible beam as it is deformed thereby delaying the buckling point as a force is applied. The form of the base member may thus be used to control (e.g. intensify) the acoustic response of the actuator.

Advantageously, the base member may be formed from an acoustically absorbing material to alter (e.g. simplify) the acoustic response of the actuator.

The acoustic device described above may be used as an ultrasound source in many different applications, as will be described below. It may be provided as a stand-alone ultrasound source or incorporated (e.g. embedded) into an object. As will now be described below, it may also form part of a kit that also includes acoustic receivers and the like. The acoustic device is particularly suited to inspecting objects manufactured by an additive manufacturing process; e.g. by selective laser melting/sintering of a powder, selective deposition and melting of a powder or wire (e.g. wire arc additive manufacturing, laser melting of blown powder) etc.

According to a second aspect of the present invention, acoustic inspection apparatus is provided that includes an acoustic device according to the first aspect of the invention and at least one acoustic receiver for attachment to an object to be inspected. The at least one acoustic receiver being arranged to receive ultrasound that has passed through the object from the ultrasonic source. Advantageously, a plurality of acoustic receivers are provided. Each acoustic receiver may comprise a stress wave sensing element. Each acoustic receiver preferably comprises a wideband Acoustic Emissions (AE) sensor. Advantageously, each acoustic receiver may comprise a piezo-electric sensing element (e.g. a standard PZT AE sensor) that directly converts the incident acoustic response into a proportional electrical signal. Such a signal can be digitised and processed to infer properties of interest about the external form or internal condition of the inspection part. Each acoustic receiver is conveniently capable of sensing the acoustic response incident at discrete spatial locations within the object. For certain applications, a distributed acoustic receiver may be provided. Each acoustic receiver may conveniently comprise a fibre-optic sensing element; for example, an array of Bragg grating elements distributed at locations along a single optical fibre. Such a fibre-optic based distributed acoustic receiver could be based upon Rayleigh, Brilliouin and/or Raman scattering and optical time domain reflectometry techniques that promote a continuous multitude of sensing locations within a single fibre.

Advantageously, the apparatus comprises a signal analyser unit for receiving and analysing signals received by the at least one acoustic receiver. The analysis performed by the signal analyser unit may comprise the processing of individual time-independent receiving channels or the combined processing of time-synchronised signals from multiple (e.g. four) receiving channels. The analysis performed will depend on the application and can be selected depending upon the complexity of the inspection part and the level of inspection required. For example, the apparatus may be used to measure or gauge external form, detect or localise near-surface defects (e.g. delamination) or sub-surface defects, estimate thickness in plate structures, measure porosity, characterise crystallographic orientation or identify material type etc. Advantageously, the signal analyser unit is arranged to perform time difference of arrival (TDOA) analysis. As explained below in more detail, such an analysis technique has a number of advantages and is well suited to a wide range of inspection tasks. As also explained below, statistical pattern recognition of complex mixtures of acoustic wave modes may also be performed by signal analyser unit.

The acoustic inspection apparatus advantageously includes an automated positioning platform. The automated positioning platform may comprise a robot, coordinate positioning apparatus (e.g. a machine tool or coordinate measuring machine), autonomous crawling vehicle etc. The automated positioning platform is preferably arranged to move the ultrasonic source relative to the object to be inspected. The acoustic source can then be moved into engagement with one or more points on the surface of the object. The act of engaging the ultrasonic source with a point on the surface of the object preferably comprises pressing the ultrasonic source against the surface with sufficient force to cause the snap-though buckling actuator to actuate (i.e. trigger) and thereby generate an ultrasound pulse that is coupled into the object. A highly repeatable and wideband structured acoustic emission waveform source can thus be provided at multiple known points on the surface of the solid inspection object.

In a preferred embodiment, the automated positioning platform may comprise a Coordinate-Measuring Machine (CMM). The CMM may provide 3-axis motion of the acoustic source. The CMM may comprise a rotary head that also allows the acoustic source to be rotated about at least one axis. A single axis rotary head, a dual axis rotary head or a rotary head having three or more axes may be provided. Providing such a rotary head allows the position of the acoustic source to be adjusted so that the acoustic source can be better manoeuvred relative to differently orientated surfaces of a solid object in an automated fashion. Such an automated process minimises inspection scan times across complex geometry parts and also reduces errors in the positioning, orientation and applied force of the acoustic device on the inspection surface. Moreover, it allows more complex scan patterns to be easily implemented where higher resolution measurements are beneficial, for example, in areas of greater complexity or more structural importance. It also facilitates adaptive scan pattern inspections based upon near real-time analysis of the measured responses.

As explained above, the acoustic inspection apparatus may also include one or more acoustic receivers. The acoustic receivers may also be moved relative to the part by the automated positioning platform. Advantageously, the one or more acoustic receivers are attached to the part being inspected. For example, acoustic receivers may be included in fixtures that held the part or may be attached to the part prior to inspection. The receiver(s) thus preferably remain static during measurement. The combination of a precision automation platform, an inherently repeatable wideband acoustic source and statically mounted receiving sensors facilitate a number of powerful pitch-catch or through-transmission ultrasonic inspection techniques, offering benefits over both conventional pulse-echo based ultrasonic NDT and passive AE inspection techniques.

The acoustic inspection apparatus may include a portable or handheld unit. The handheld unit may comprise, for example, a bolt tensioning device. The acoustic source is preferably incorporated in the handheld unit. Manual placement of the handheld unit on an object (e.g. a bolt) may be used to trigger the snap-through buckling source. The present invention thus also extends to a bolt-checking unit that comprises an ultrasonic source comprising a snap-through buckling actuator. A handheld bolt checker comprising an ultrasonic source comprising a snap-through buckling actuator is also encompassed.

As an alternative to providing the device as part of an inspection apparatus that is separate to the object being inspected, the present invention also extends to an acoustic device that is incorporated into the object being inspected. In such an arrangement, the snap-through buckling actuator of the device is preferably arranged to generate an ultrasound pulse for propagation through the object. The snap-through buckling actuator may be actuated by an external stimulus (e.g. a magnet field applied to the object) or it may use or harvest energy from vibrations or stresses within the object itself. If not externally actuated, the snap-through buckling actuator may periodically generate an ultrasound pulse. The device of the present invention can be embedded in medical implants (e.g. hip or knee implants) or used to inspect medical implants (e.g. dental implants, bone anchored hearing aids etc). The object in which the device is incorporated may be an oil pipe (e.g. for corrosion detection), a building structure (e.g. bridge, road, rail track etc), or an aircraft structure, etc. The device may be embedded in the object (e.g. during manufacture), attached (e.g. welded) to the object or it may be formed as part of that object during manufacture (e.g. during an additive manufacturing process).

The device of the present invention can provide an acoustic sensing system for online, in-process and in-situ health condition monitoring of objects that comprise, for example, high-value or safety-critical mechanical components, structures or moving machines. Conveniently, a static distributed array of one or more snap-through buckling actuators may be attached to the external surface of, or embedded directly within, the bulk of a monitored object. This may be done during manufacture or as a retrofit. The acoustic inspection waveform generated by each actuator can propagate through the bulk or across the surface of the object being monitored. An array of one or more acoustic receivers may be attached to and/or embedded into the object. The arrangement may implement inspections using, for example, pulse-echo, pitch-catch or through-transmission ultrasonic techniques.

As described in more detail below, it should be noted the device may be used as or in combination with an energy-harvesting device. This may be most usefully for applications in which snap-through buckling actuators are distributed across large remote structures that vibrate either determinsitically or stocastically (e.g. wind, wave vibration) and where electrical power is not readily available (e.g. on aerospace structures) or where alternative energy harvesting methods are impractical or less efficient (e.g. solar).

According to a third aspect, the invention provides a method for acoustically inspecting an object using an ultrasound pulse, comprising the step of using a snap-through buckling actuator to generate the ultrasound pulse. The method may also include coupling the ultrasound pulse into the object. The method may include any of the features of the apparatus, and any steps involved in using such apparatus, that are described above. For example, the method may include the step of receiving the ultrasound pulse after it has propagated in or through the object.

According to a further aspect of the invention, an acoustic device for inspection of an object is provided, the device comprising an ultrasonic source including an actuation means for applying a compression force to the surface of an object and suddenly removing said compression force. The actuation means may be a buckling actuator, a snap-though buckling actuator or the like. The actuation means is preferably mechanically actuated (e.g. not electrically powered). Preferably, actuation is achieved by loading the device into the surface of the object being inspected. In a further aspect, there is provided an acoustic device for inspection of an object, the device comprising an ultrasonic source comprising a snap-through buckling actuator. Such a device may have any one or more of the features described herein.

According to a further aspect of the invention, an acoustic device for inspection of an object is provided, the device comprising an ultrasonic source including an actuation means for converting stored potential energy into a transient pulse of acoustic energy (i.e. an acoustic pulse). The actuation means can preferably be repeatedly actuated. The actuation means may include any one or more of a spring, buckling cantilever, shearing action, impacting member etc. An energy harvesting means may be provided for generating the store of potential energy.

According to a further aspect of the invention, there is provided an object comprising integrated lifetime monitoring apparatus, the lifetime monitoring apparatus comprising a snap-through buckling actuator. The snap-through buckling actuator may be embedded in the object. The snap-through buckling actuator may be manufactured during manufacture of the object. The object may be a medical implant (e.g. an artificial hip joint, knee joint etc). The object may be a large structure (e.g. bridge, pipeline, beam etc). The lifetime monitoring apparatus may also include one or more acoustic receivers. The apparatus may also include any one or more of the other preferred features described herein.

The present invention will now be described, by way of example only, with reference to the accompanying drawings in which:

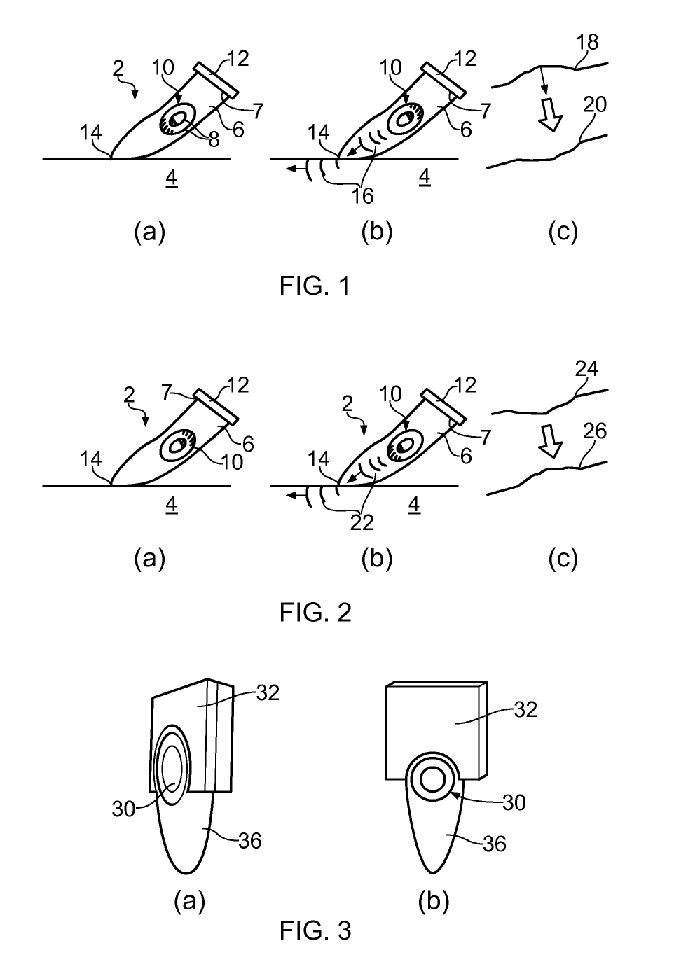

FIGS. 1(a)-(c) show a snap-through buckling actuator being loading on to an inspection surface,

FIGS. 2(a)-(c) show a snap-through buckling actuator operating in a snap-back mode when being withdrawn from an inspection surface.

FIGS. 3(a)-(b) show a conformal shape clamping feature of a snap-through buckling actuator,

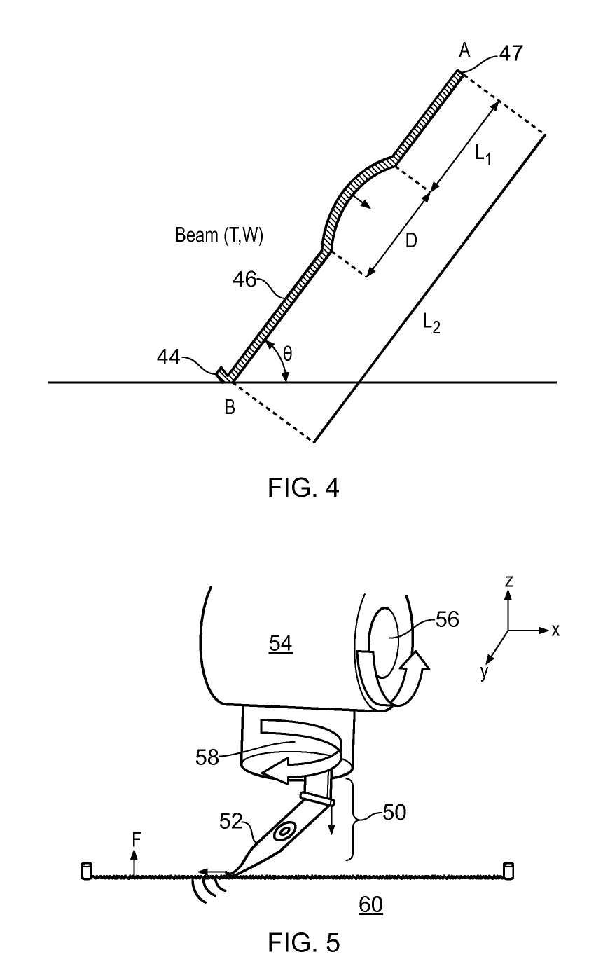

FIG. 4 illustrates some adjustable parameters of a snap-through buckling actuator,

FIG. 5 shows a snap-through buckling actuator carried by a CMM measurement head,

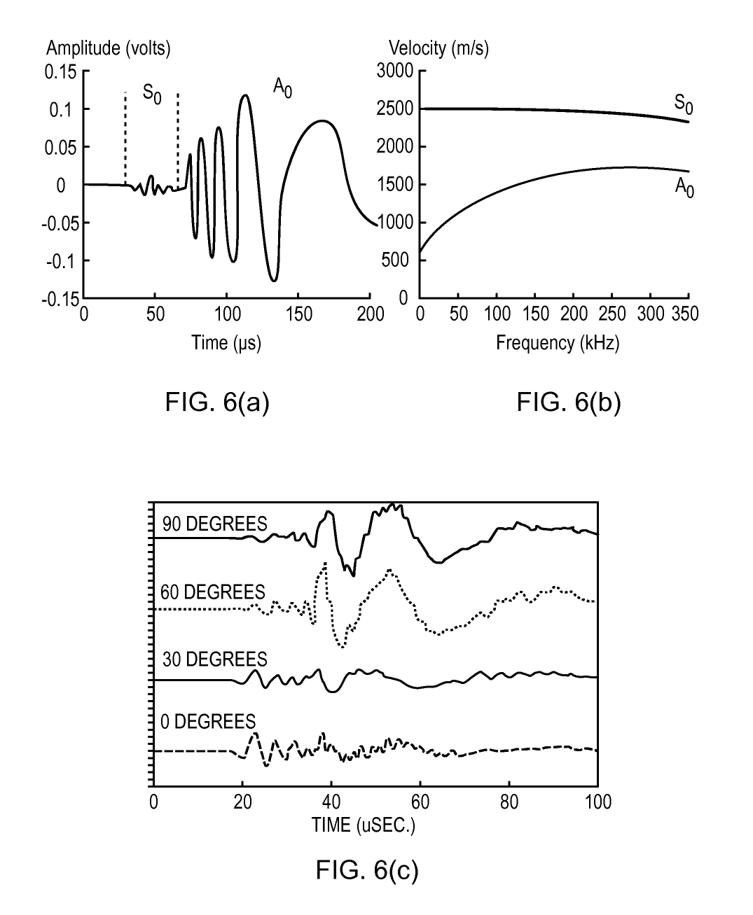

FIGS. 6(a)-(b) illustrate the amplitude and phase velocity of the acoustic signal generated by a snap-through buckling actuator in a plate-like structure and FIG. 6(c) shows fundamental order extensional and flexural mode separation for different angles of incidence,

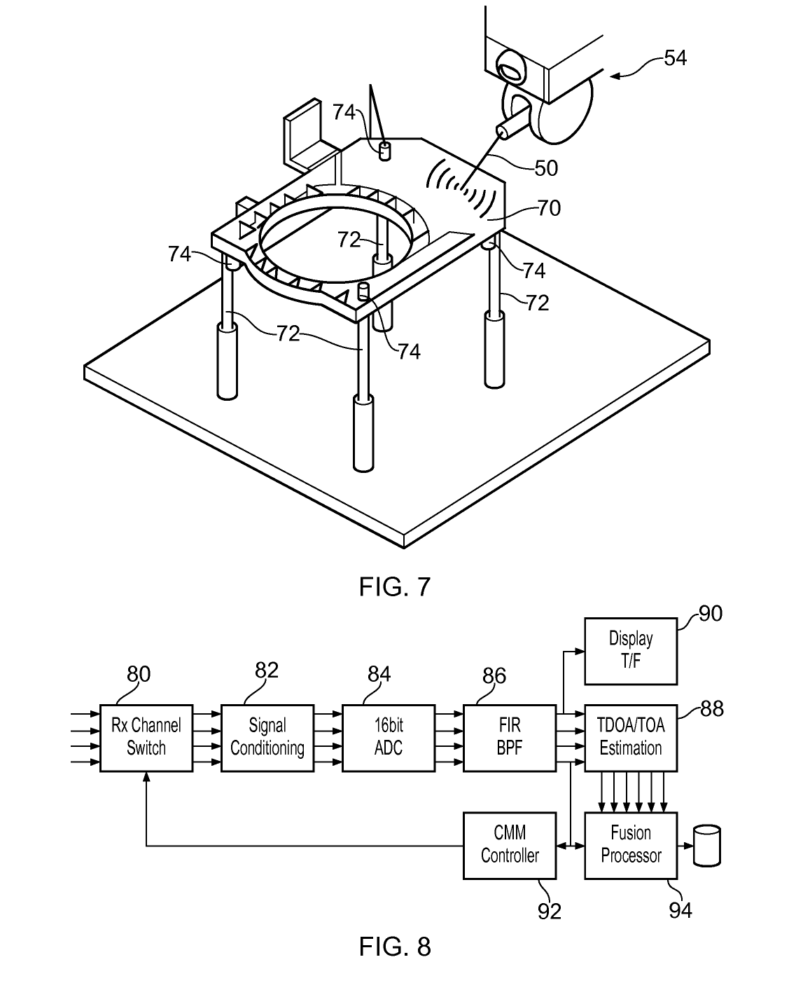

FIG. 7 illustrates inspection of a complex geometry part using a snap-through buckling actuator carried by a CMM,

FIG. 8 illustrates a time synchronous signal processing chain for a receiver system comprising a plurality of statically mounted sensors,

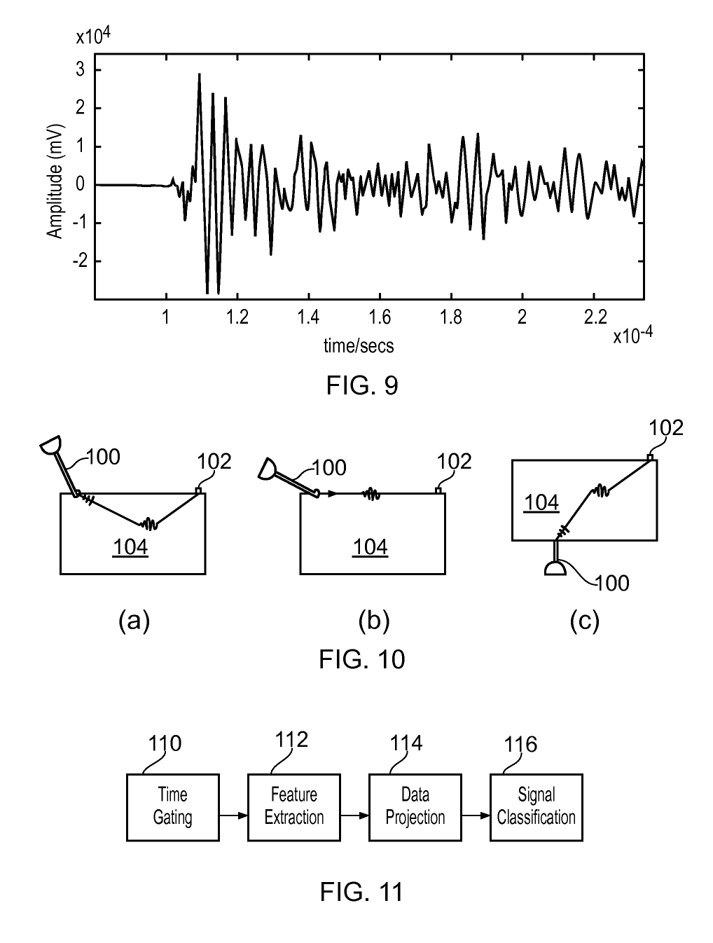

FIG. 9 is an example plot of the repeated structured acoustic emission signal,

FIGS. 10(a)-(c) show three examples of acousto-ultrasonic waves transmitted through parts,

FIG. 11 shows generic sequential data processing stages for automatically classifying measured acoustic signals,

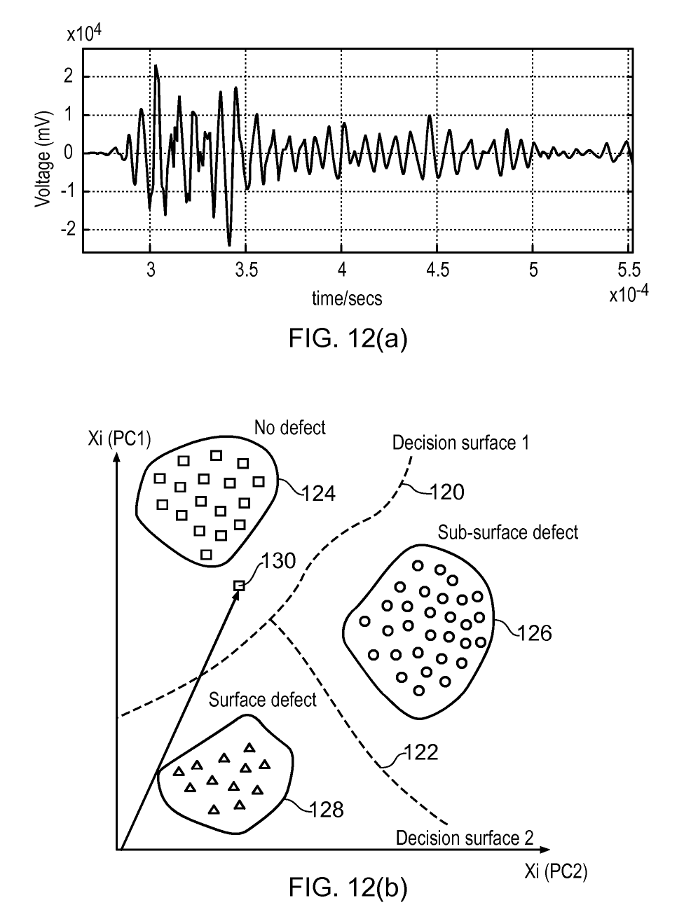

FIG. 12(a)-(b) illustrate a time domain plot and automatic defect detection or conformity gauging,

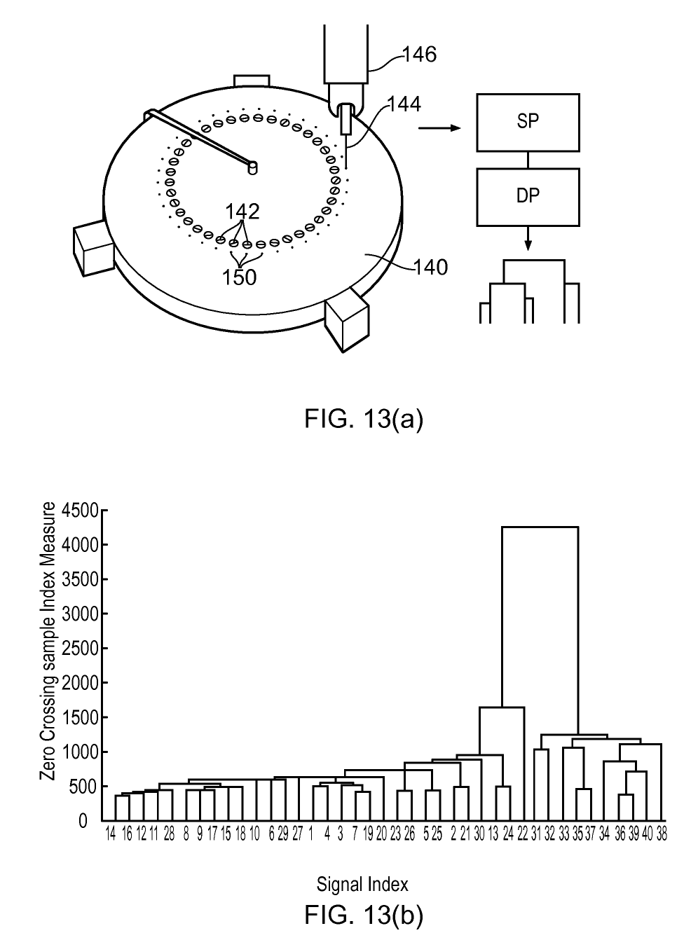

FIGS. 13(a)-(b) illustrate automatic conformity gauging of a large number of nominally identical features and how this can be visualised using a clustering plot,

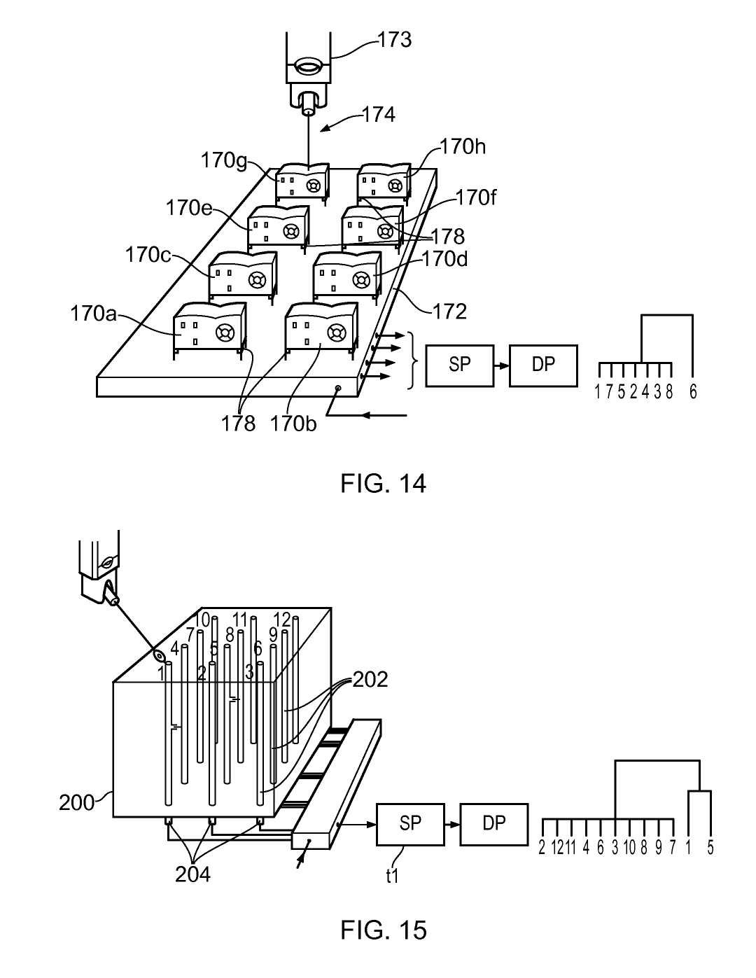

FIG. 14 illustrates gauging eight nominally identical parts using a CMM,

FIG. 15 illustrates the automatic detection of surface defects or delamination within small diameter holes,

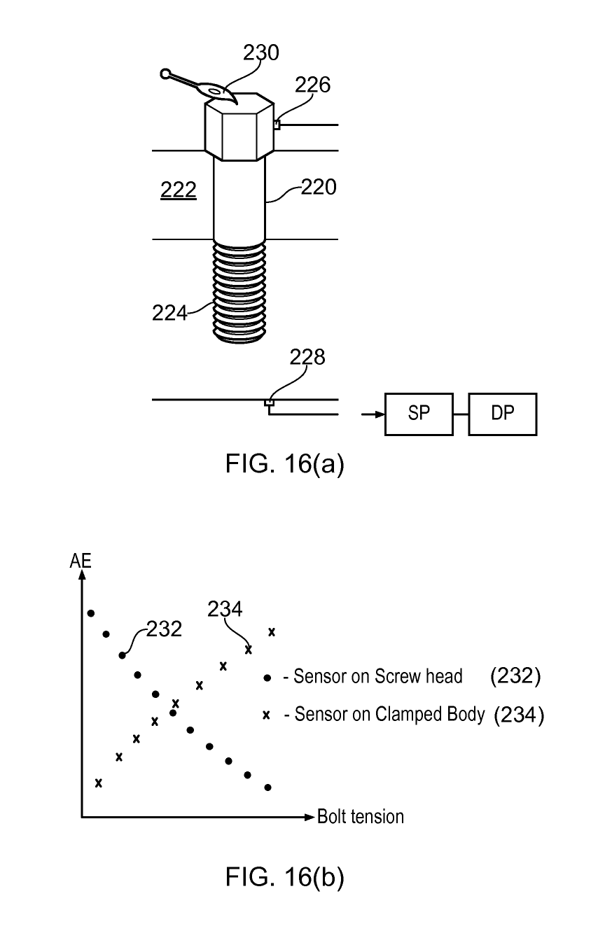

FIGS. 16(a)-(b) illustrate use of the snap-through buckling actuator for screw verification purposes,

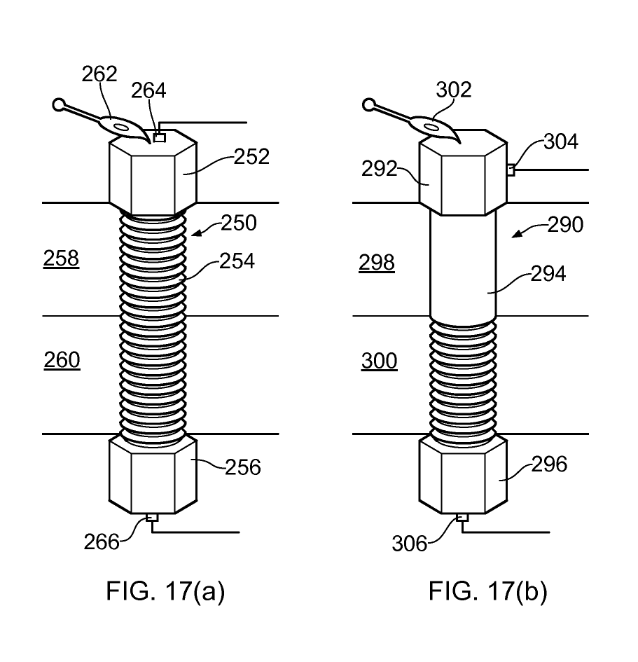

FIGS. 17(a)-(b) show two potential through-transmission bolt tension estimation configuration,

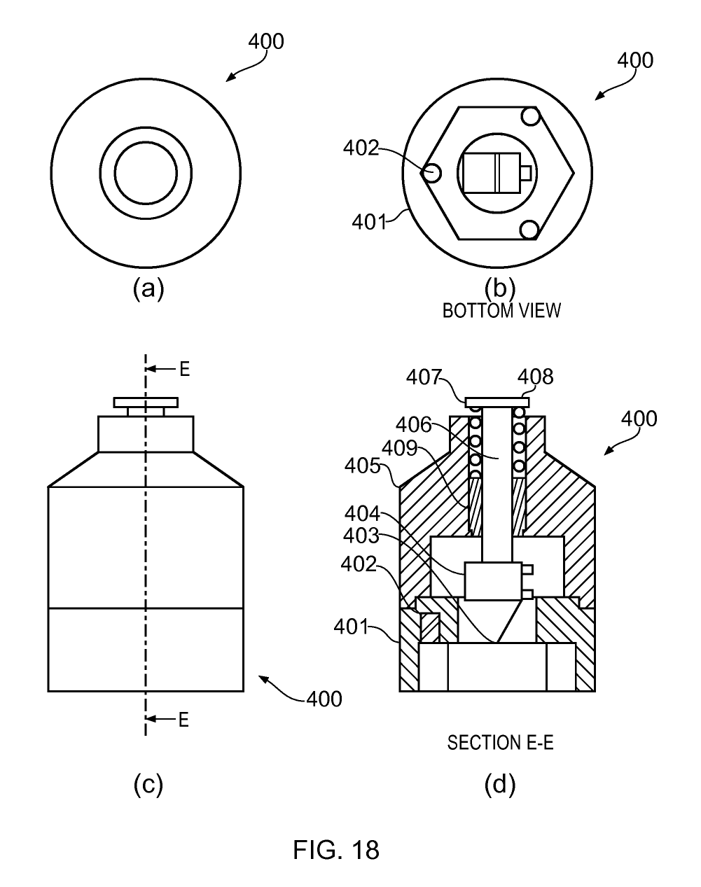

FIGS. 18(a)-(d) show a hand-held bolt fastener device comprising a snap-through buckling actuator,

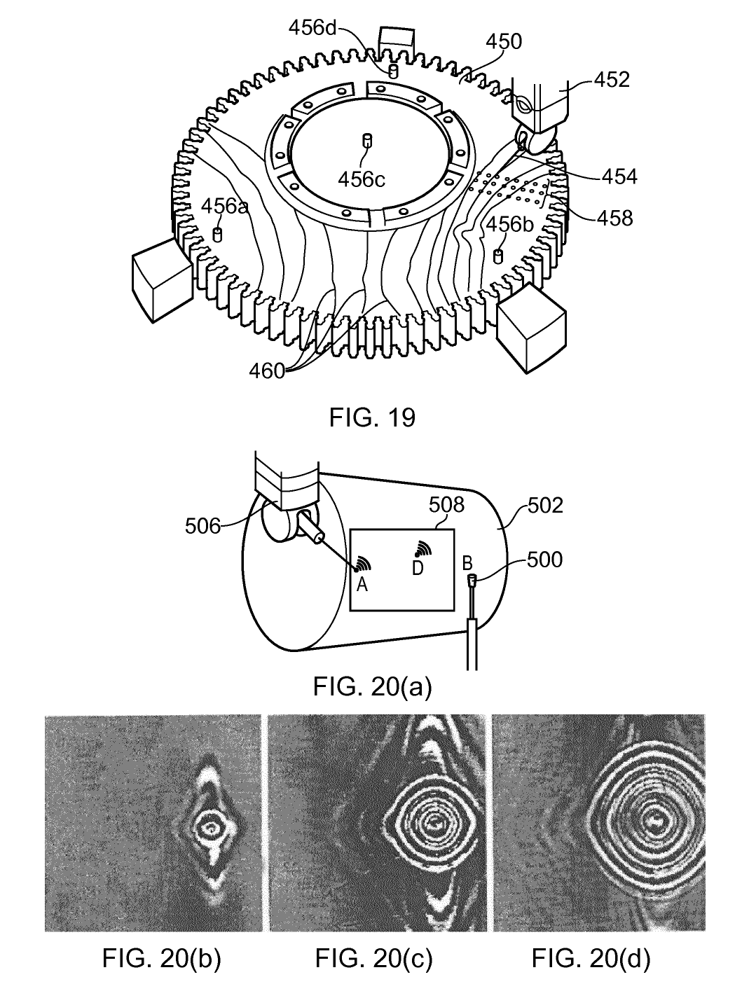

FIG. 19 illustrates high resolution scanning across a complex geometry part,

FIGS. 20(a)-(d) shows high resolution scanning applications and acoustic surface waveform visualisation,

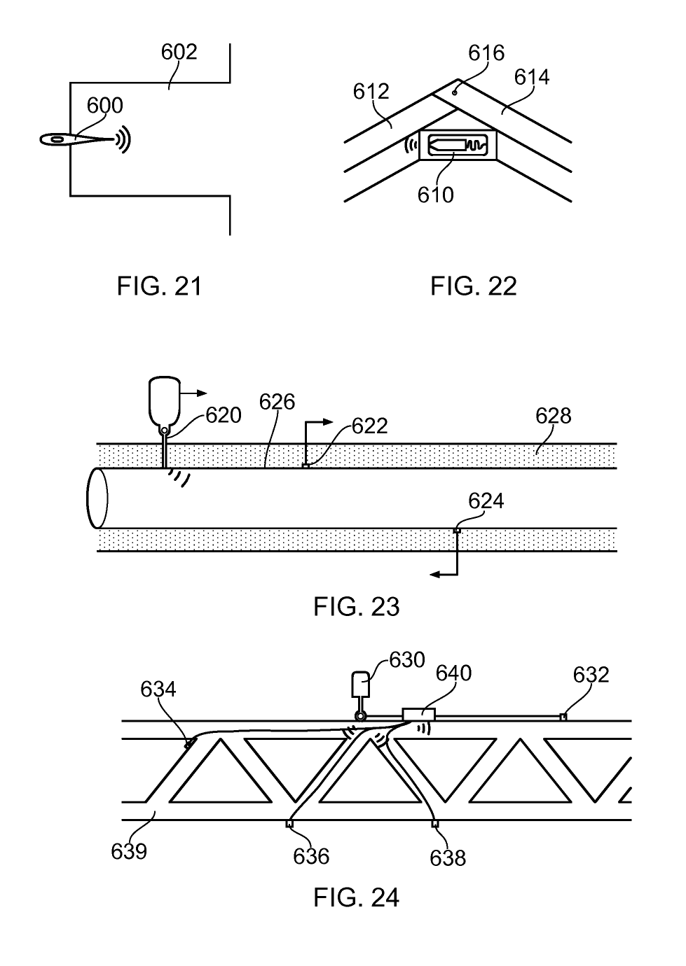

FIG. 21 shows a snap-through buckling actuator welded to an object,

FIG. 22 shows a snap-through buckling actuator connected to two linked beams for lifetime monitoring purposes,

FIG. 23 shows a snap-through buckling actuator and receivers attached to an oil pipe for lifetime monitoring purposes,

FIG. 24 shows a snap-through buckling actuator and receivers attached to a bridge structure for lifetime monitoring purposes,

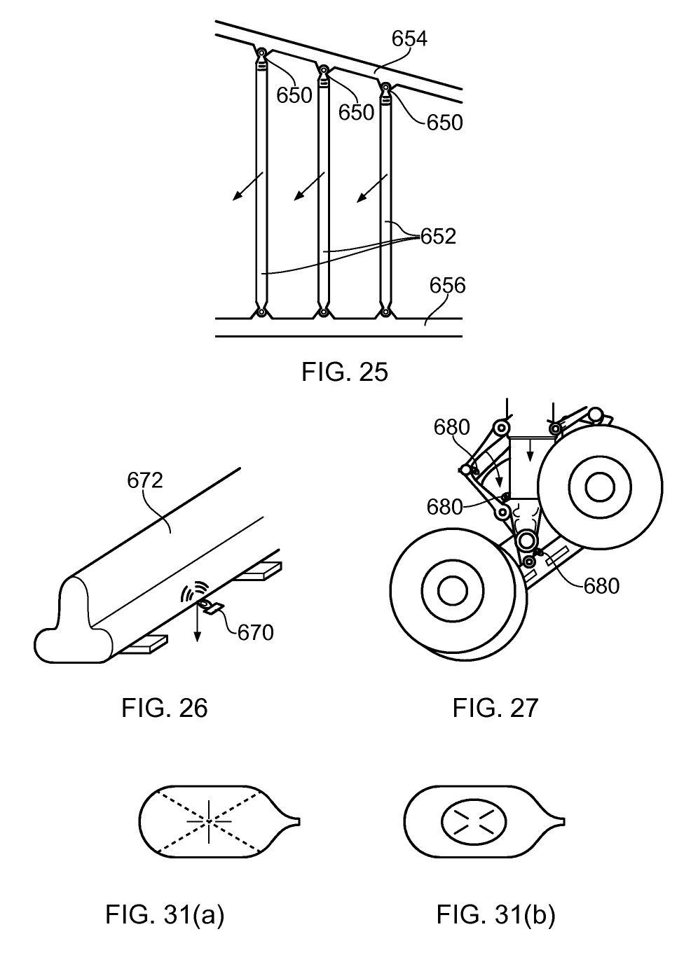

FIG. 25 shows a snap-through buckling actuator attached to suspension bridge wires for lifetime monitoring purposes,

FIG. 26 shows a snap-through buckling actuator attached to a rail track,

FIG. 27 shows snap-through buckling actuators attached to aircraft landing gear,

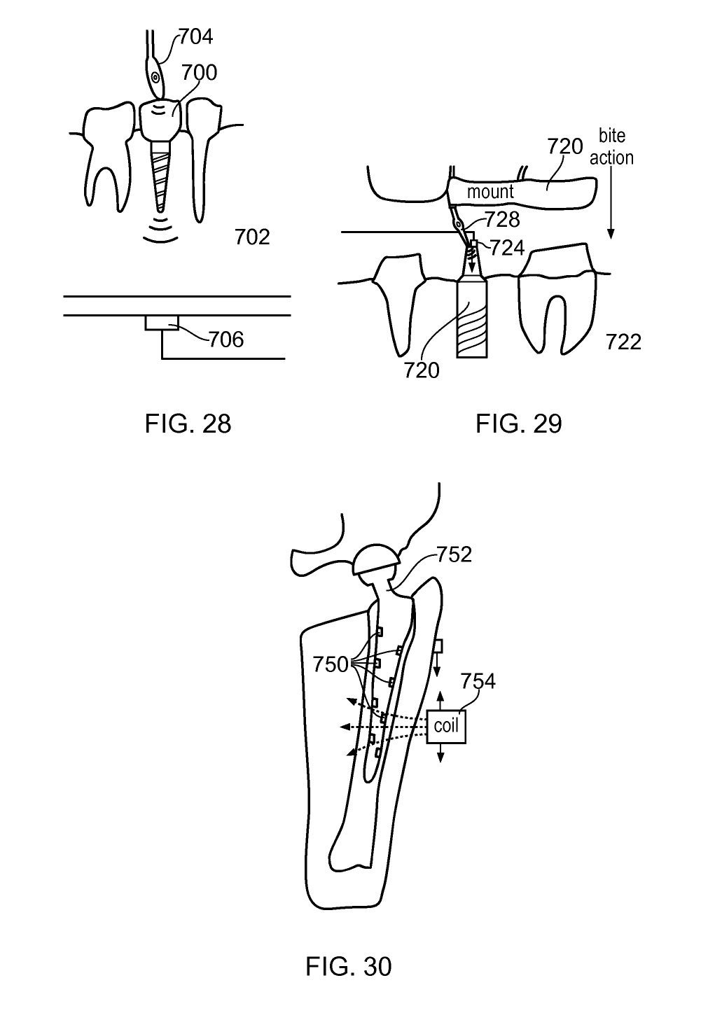

FIG. 28 shows inspection of a dental implant using a snap-through buckling actuator,

FIG. 29 shows inspection of a dental implant using a bite-down plate that includes a snap-through buckling actuator,

FIG. 30 shows a hip implant in which a plurality of snap-through buckling actuators are embedded, and

FIGS. 31(a) and (b) show two alternative designs of snap-through buckling actuator.

Referring to FIGS. 1(a) to 1(c), the structure and operation of an acoustic device of the present invention that comprises a snap-through buckling actuator as an ultrasound source will first be described.

FIGS. 1(a) and 1(b) show the snap-through buckling actuator 2 engaged with a solid surface of an object 4. The snap-through buckling actuator 2 comprises a beam 6 that is formed from a thin metallic plate (e.g. a plate of austenitic stainless steel). The beam 6 comprises a plurality of concentric circular indentations 8 that together form a dome feature 10 that provides a constrained high velocity snap-through movement when placed under tensile load and/or flexural stress. The indentations 8 forming the dome feature 10 may be formed in any suitable way, for example they may be stamped into the plate with a tool and die or formed via a chemical etching process. The proximal end 7 of the beam 6 is held by a base member 12 and the distal end of the beam 6 forms a tip 14 for contacting the surface of the object 4.

FIG. 1(a) illustrates the acoustic actuation process as the snap-through buckling actuator 2 is loaded onto the inspection surface of the object 4. As shown, the inclined beam 6 comes into contact with the inspection surface via the free moving tip 14 and begins to bend as it is pressed down. As explained below, the proximal end 7 of the beam 6 may be held by the moveable member of an automation platform and the relative motion of the snap-through buckling actuator 2 towards the surface may be controlled by the platform. When the flexing of the beam 6 that is caused by loading it into the surface exceeds a certain limit, the dome feature 10 snap-through buckles to the other side of the beam centre-line (i.e. towards the inspection surface of the object 4).

FIG. 1(b) illustrates the acoustic wave 16 that is generated by the energy released by the snap-through buckling process. The acoustic wave 16 is thus coupled from the beam 6 into the object 4. Properties of this acoustic wave and examples of how it can be detected will be described in more detail below.

FIG. 1(c) illustrates the pre-buckled dome feature 18 and how this snap-through buckles to the buckled dome feature 20. After snap-through buckling has occurred, the beam 6 stores potential energy as it is a non-linear mono-stable buckling structure and has a natural tendency to return to its rest state.

Referring next to FIGS. 2(a)-(c), it is noted that a reverse buckling movement is also induced in the snap-through buckling actuator 2 when the flexural stress (e.g. as applied by the automation platform) is relaxed or removed. FIG. 2(a) illustrates the beam 6 loaded onto the surface after it has buckled. As the snap-through buckling actuator 2 is removed from the surface, a snap-back actuation event or trigger occurs which causes a similar highly controlled acoustic pulse to be generated. FIG. 2(b) illustrates the acoustic wave 22 generated by this process and FIG. 2(c) shows the dome feature 18 returning from the buckled state 24 to non-buckled state 26. A monostable snap-through buckling actuator 2 can thus generate an acoustic signal buckling into an unstable configuration and also on returning to a stable configuration.

Finite element modelling of the predicted buckling modes within the beam 6 of the snap-through buckling actuator 2 indicate that the peak stress concentration occurs at the outermost concentric circle of the series of indentations 8 near the proximal end 7, although increased stress is actually concentrated around the entire buckling circle. As such, the elastic deformation that occurs during the snap-through buckling process causes the generation of an ensemble of stress wave events that culminates in the overall generated acoustic response. This ensemble stress wave signal, also referred to as the structured acoustic emission time series (SAETS), propagates to the tip 14 where it transmits into the inspection object 4. It should be noted that the snap-through buckling actuator could also be configured to operate in the same manner as Hsu-Nielson source; i.e. the buckling action could cause surface recoil and thereby generate stress wave.

Referring to FIGS. 3(a) and 3(b), a clamping sleeve 32 for a snap-through buckling actuator is illustrated. The clamping sleeve 32 is rigid and is attached to both side of the beam 36 (although it could be attached on only a single side). The clamping sleeve 32 also partially surrounds the dome feature 30 (i.e. the snap-through buckling feature) of the beam 36. In particular, the clamping sleeve 32 is shaped to match the shape of the dome feature 30 and further restricts the linear flexural strain or displacement within the beam 36 as it is loaded against the inspection surface, whilst retaining or amplifying the non-linear snap-through motion. In other words, the clamping sleeve 32 intensifies or otherwise alters the motion or velocity of the snap-through buckling element (e.g. by effectively delaying the buckling actuation point) and thus alters the generated signal response. The clamping sleeve 32 may be made from a material that absorbs ultrasound energy, thereby further altering the signal response.

Referring to FIG. 4, the effect on the acoustic generation properties of various parameters of a beam 46 that provides the snap-through buckling effect will be described.

Firstly, it should be noted that the material forming the beam 46 will have a fundamental effect upon the generated acoustic waveform. For a metal beam 46, the metallurgy can be selected to control the acoustic waveform that is generated. Specifically, the metallic hardness and modulus of elasticity will affect the amplitude of the generated acoustic signal. These parameters can thus be adjusted to increase the source signal-to-noise ratio (SNR).

Additional design parameters of the beam 46 that can be tailored to manipulate the structured acoustic emission are shown in FIG. 4. For example, reducing the buckling dome diameter (D) or its surface area or increasing plate thickness (T) will restrict dome compliance (i.e. reciprocal stiffness) and generate a higher velocity and more dampened snap-through buckling response, resulting in a wider band acoustic emission waveform. The actuator can also be scaled to generate a higher frequency response and thus excite higher order inspection modes; e.g. first, second or third Lamb wave modes in plates or surface acoustic waves above the Rayleigh dispersion limit. Also, the axial position of the dome relative to the tip 44 and the encastre 47, determined by L1 and L2, effect the boundary condition constraints at the point of contact with the inspection part, affecting both the force required to trigger the actuator and the resulting stress wave structure.

The snap-through buckling actuator can be considered as a type of waveguide delivery device because it generates a structured acoustic time series remotely on the buckling plate (i.e. the beam 46) that subsequently propagates into the inspection surface. The plate or beam 46 is thus an acoustic waveguide that serves to concentrate the generated acoustic energy at the tip 44. The shape of the beam 46 is thus another design parameter that can be altered as required; e.g. the plate may be tapered towards the tip 44.

The actuator tip 44 that contacts the inspection surface of the object can also be provided in different forms depending on the particular application. The tip 44 may comprise a small hemi-sphere machined directly into the plate or beam 46 to minimise attenuation and avoid additional wave mode conversion at the interface. Alternatively, the actuator tip 44 could be made from any material with suitable acoustic and mechanical properties (e.g. with a suitable acoustic impedance). For example, a small spherical tip made from a suitable hard material (e.g. zirconia or ruby) would also facilitate low friction sliding across the inspection surface, with obvious scan speed benefits without resorting to liquid lubrication. As explained below, the ability to slide laterally across an inspection surface also has benefits when the snap-though buckling actuator is used on a CMM.

It is preferred that the actuator tip 44 has a relatively small surface area (compared with the acoustic wavelength) and thus forms a Hertzian contact with the inspection surface. Alternatively, the beam 46 and shape of the actuator tip 44 could be configured to induce a more directional transmitted waveform. Alternatively, the tip 44 could be severely sharpened to optimise the point source strain energy or displacement (e.g. 100 μm radius) and wavefront omni-directionality across the inspection surface. Although a single tip is described above, the beam 46 could alternatively carry a plurality of tips that, for example, form a phased array capable of spatially filtered actuation (e.g. by providing tip spacing within λ/2).

In all cases, an advantage of the snap-through buckling actuator is that it can use a completely dry-contact point source on the inspection surface. This avoids the need to use a couplant gel or the like, although such a couplant could be used if desired.

Referring to FIG. 5, an acoustic device 50 incorporating a snap-through buckling actuator 52 of the type described above with reference to FIGS. 1 to 4 is shown mounted to a rotary probe head 54 of a coordinate measuring machine (CMM). The rotary probe head 54 provides rotation of the acoustic device 50 about first and second rotary axes 56 and 58. The rotary probe head 54 is attached to the quill of a CMM (not shown) and can be translated along three mutually orthogonal axes (x, y, z) relative to an inspection surface 60 that exhibits a rough surface finish.

The arrangement shown in FIG. 5 allows the acoustic device 50 to be driven into contact with the surface to be inspected 60 in an automated manner. In particular, such an arrangement facilitates full hemi-spherical probe coverage. As shown, when the actuator 52 is loaded onto the inspection surface 60 by constant velocity motion along the surface normal F, the bending plate of the snap-through buckling actuator 52 induces a small controlled lateral motion of the free moving tip across the surface before and during the snap-through buckling event. This serves to penetrate through the outer rough asperity layer reducing any ultrasonic coupling variability that may otherwise occur without the use of a liquid or gel couplant.

Referring to FIGS. 6(a) to 6(c) it will be described how the design parameters of the snap-through buckling plate and the form of the tip can be altered to manipulate the source signal and/or select favourable wave modes for non-destructive testing (NDT) inspections. In particular, the waveform generated by the acoustic device 50 may be optimised for particular applications.

As illustrated in FIGS. 6(a) and 6(b), generation of the fundamental zero order Lamb wave modes (i.e. the fast S0 and the dispersive A0 waves) can be usefully isolated from higher order modes (i.e. they uniquely exhibit no high pass frequency cut-off in the dispersion curve) and are useful for many types of non-destructive inspection within plate-like structures (e.g. aerospace metallic or composite skins). Such modes can be excited by the actuator and are often most sensitive to propagation across structural defects (i.e. discontinuities) where wave scattering and mode conversions occur (i.e. redistribution of wave energy over the infinite number of possible Lamb wave modes), thus perturbing the shape of the inspection signal. This effect can be usefully exploited by applying acousto-ultrasonic pattern recognition techniques to received signals. However, other form gauging and dimensional metrology tasks can also be accomplished by generation and reception of such modes. For example, the often higher SNR dispersive A0 mode can be used to accurately estimate wave speed or phase velocity directly in anisotropic structures and this may be used to infer plate thickness or changes in it (e.g. for single crystal super alloy turbine blades, composite laminates, CFRP) or even indicate defects where a high concentration of measurements can be made (e.g. ultrasonic CT methods). The faster S0 mode is non-dispersive yet its higher propagation speed is strongly orientation dependent in anisotropic materials (e.g. in composites) and thus also has NDT applications (e.g. crystal orientation estimation).

It is noted, within the context of designing a buckling member that could manipulate A0 and S0 modes, that the A0 mode velocity depends strongly upon the flexural stiffness of the waveguide whereas the S0 mode is more dependent on the in-plane stiffness of the plate. It is also noted that accurately controlling the angle of incidence at which the actuator tip is applied to the inspection surface using a precision automation platform (e.g. the 5-axis CMM described with reference to FIG. 5) allows the ratio of A0 and S0 amplitudes within the actuator response to be controlled; this is illustrated in FIG. 6(c). Equally, in thicker inspection objects, the snap-through actuator can be designed to promote the propagation of various Rayleigh surface wave modes for use in interface integrity inspection (e.g. NDT for rail inspection).

Referring to FIG. 7, an example will be given of how the CMM and acoustic device 50 described with reference to FIG. 5 can be used. As explained above, the acoustic device 50 is attached to the measurement head of a CMM. This allows the acoustic source to be delivered at any selected actuation node across the surface of an inspection part 70.

In the example of FIG. 7, the inspection part 70 is held in fixturing components 72 that comprise wideband acoustic emission (AE) sensors 74. The acoustic sensors 74 may be embedded in the fixturing components 72 so as to allow the inspection part 70 to rest directly on the wear plates of such sensors. Alternatively, the wideband acoustic sensors may be clamped off the fixturing locations. In either type of receiver mounting, a coupling material (e.g. gel or grease or a solid hydrophilic polymer) may be employed to maximise ultrasonic transmission and reduce signal variability. For embedded AE sensors, the absolute intra-array distances may be fixed and can thus be calibrated. For example, positional calibration measurements or accurate surveying of all AE sensor locations across the part can be conducted using known (e.g. touch probe based) metrology techniques.

The plurality of wideband acoustic emission (AE) sensors 74 thus receive the acoustic signals coupled into the inspection part 70 from the acoustic device 50. The wideband acoustic emission (AE) sensors 74 thus form a static receiver array that is acoustically coupled to the part 70 and can be accurately surveyed; this significantly reduces signal variability compared with a scanning technique involving a moving receiver that has to be continually re-conformed or re-coupled to the inspection surface.

FIG. 8 shows an example of analysis hardware for processing the signals received from four independent acquisition channels. Each acquisition channel may, for example, be coupled to one of the acoustic emission (AE) sensors 74 described above with reference to FIG. 7.

It is noted that the signal measured by each of the very sensitive wideband AE sensors 74 is typically extremely small and requires pre-amplification prior to digital acquisition. This may require a switchable or adapting SNR gain pre-amp (e.g. 0/20/40 AEdB). As with any conventional passive AE system, the receiving channels also require some front-end electronics (e.g. a signal comparator circuit) that allows time-synchronous digital acquisition to be triggered only when one of the AE sensors receives a sufficient threshold voltage or if acquisition is externally triggered. This is advantageous because many operational scenarios exist in which the receiving channels do not receive an explicit external acquisition trigger signal from the automation platform controller yet can acquire time-synchronous data from all channel simultaneously. As such, most of the inspection techniques do not rely upon knowing the absolute time at which each actuation occurs across the inspection part, but only the relative time that the response arrives at each of the enabled sensors. However, the ability to acquire synchronised data when triggered from an external signal indicating that an actuation has occurred on the inspection part is also preferable, as it can be used to estimate wave speeds (e.g. phase velocity) directly between source and receiver. Alternatively, this may be done explicitly by mounting one of the time synchronised receiving sensors on the actuator buckling plate.

The analysis hardware comprises a channel switch 80 that receives a plurality of sensor signals and has a control input from the CMM controller 92. The sensor signals are then passed to a signal conditioning unit 82 before being passed to an analogue-to-digital converter (ADC) 84. Prior to digitisation within the ADC 84, various analogue signal conditioning steps are performed by the signal conditioning unit 82, for example high pass filtering and anti-aliasing filtering.

Due to the wide dynamic range requirements for sensing the acoustic actuator response within various materials at various propagation distances (>85 AE dB), a minimum of a 16-bit ADC would be recommended with a sample rate that facilitates sufficient over-sampling for the measurement band occupied by the actuator (e.g. >10 msps for 2 MHz measurement band).

After being digitised by the ADC 84, the resulting four digitally encoded signal wave-streams are further processed within the receiver hardware using either a general purpose processing unit or more usually, a dedicated processor (DSP). This digital signal processing comprises a linear bandpass filtering unit 86 and a unit 88 for time gating and time difference of arrival (TDOA) estimation between each pair of sensors. Such accurate TDOA estimation may be based upon signal processing techniques used to accurately estimate signal time of arrival in complex waveforms, including wavelet decomposition or generalised cross-correlation incorporating spectral pre-whitening to remove smearing errors.

The filtered, digitised, signals may be displayed to a human observer via a suitable display 90. For example, a time, frequency or other type of plot may be shown. In the present example, a spectrogram is used to display the complex signals because this can often emphasise important modal information that may indicate a defect. However, the complex filtered AE signals will more usually be compiled for subsequent use within the data processing chain (e.g. within fusion processor 94), as described later, where an automatic defect detection decision or conformity gauging classification of the inspection part is made.

The channel switch 80 is incorporated into the receiver electronics for use during the inspection of large individual parts or several identical parts that are fixtured or mounted within the same CMM. This facilitates electronic switching between a multitude (e.g. more than four) of receiving sensors across the inspection part or parts without the need for individual digital acquisition channels for all of the deployed sensors. That is, a sub-set combination of sensors become enabled prior to each actuation depending upon which is most relevant, which registers the largest amplitude signal or which is physically closest to the current actuation point. Irrespective of whether the switching is determined by the location of the actuation on the inspection part and the receiving array is explicitly informed which combination of receive channels should be enabled or whether it involves some form of more automated switching (e.g. a structural neural system concept), this arrangement has been found to significantly reduce the receiver hardware costs and the overall inspection time.

As explained above, the snap-through buckling actuator generates extremely repeatable waveforms in both phase and amplitude from successive loadings on the inspection surface. In particular, it is observed that the wave velocity is invariant over successive actuations. This is a substantial benefit of the snap-through buckling actuator when used within a multitude of pitch and catch non-destructive inspection techniques.

FIG. 9 illustrates the repeatable yet complex waveform generated by the snap-through buckling actuator. In particular, FIG. 9 shows over-plotted raw AE responses measured by a wideband AE sensor mounted on an aluminium plate when ten successive snap-through actuations are induced on a CMM with a transmit-receive distance of 4 cm. The time domain plot illustrates that the measured response has considerable fine-scale shape complexity, yet this is repeated in phase and amplitude from one actuation to the next. It is also found from triggering the actuator at identical points on several identically shaped isotropic and homogenous yet complex geometry parts that the same absence of fine-scale shape variability can be achieved.

The CMM based systems described above combine an efficient mechanical actuator (i.e. the snap-through buckling actuator) with a precision automation platform. This enables the delivery of a repeatable AE source with accurate and flexible Tx scan patterns across an inspection part. The acquisition of time synchronised measurements across a spatially distributed array of acoustic receivers thus provides a powerful and flexible basis upon which the inspection data can be interpreted. This allows the use of any one of a multitude of different data processing methods, relying on different levels of spatial and temporal data interpretation.

Two classes of measurement will now be described in detail that relate to two scanning approaches and the data processing associated therewith. In the first class, useful information is automatically interpreted within an inspection from only a sparse number of actuation nodes. Subsequent measurements and defect or non-conformity detection decisions are then made directly at the signal level. This first class of measurement will herein be termed “sparse resolution inspections”. In a second class, useful inspection data is automatically compiled for the part under test from high granularity actuations and many measurements across the part so as to generate C-scan imagery. As such, defect detection and location decisions are more often induced at the image level, using an appropriate statistical classification approach (e.g. CFAR/Neyman-Pearson). It is noted that an automated detection decision for such high resolution imaging may, in practice constitute an automatic aid to an operator. This second class of measurement will herein be termed “high resolution imaging”.

Referring to FIGS. 10 to 18, various examples of sparse resolution inspections will be described.

Apparatus comprising a snap-through buckling actuator has an advantage over conventional automated pulse echo ultrasound probing employed in many geometries (e.g. for plate-like structures) in that it can exploit wider coverage guided wave inspection methods. Lamb waves and surface waves induced by the actuator can propagate efficiently across and throughout the inspection part, including within remote internal surfaces and volumetric features, to one or more distributed receiving locations. Therefore, a potentially adequate level of conformity gauging or low resolution defect detection may be inferred more quickly from considerably fewer inspection nodes across the part. Various modal AE techniques involving identifying the incidence of useful propagating Lamb wave modes within the low ultrasonic band (e.g. A0 and S0 modes) or propagation surface wave (e.g. Rayleigh) time of flights or the wave speed distribution across each source and receiver can infer information about dimensional form. Moreover, it is possible to provide the snap-though buckling actuator as part of a self-contained acoustic emission probe that can be automatically replaced by either a conventional metrology touch probe or any other sensor capable of estimating form. Results derived from the acoustic emission probe can then be validated or statistically fused with other measurements to increase accuracy or reduce inspection time.

In contrast, for more complex geometry parts inherently unsuited to such modal inspection techniques, various acousto-ultrasonic techniques based upon statistical pattern recognition may be applied. In particular, FIGS. 10(a)-10(c) show three basic pitch and catch acousto-ultrasonic scenarios in which defect detection is performed by automatically recognising some change in the received signal.

FIG. 10(a) shows an acoustic device 100 comprising snap-though buckling actuator and a receiver 102. A near-surface defect (e.g. a delamination) in a composite or additively manufactured plate 104 may be indicated by strong modal perturbations in the received signal (e.g. Lamb wave scattering or mode conversion at the discontinuity interface).

FIG. 10(b) shows the acoustic device 100 and receiver 102. In this example, the acoustic device 110 is orientated at a shallow angle to the surface of the plate 104. A subtle change in the signal shape or propagation path may then be interpreted in order to detect a surface indentation (e.g. impact damage) in the plate 104.

FIG. 10(c) shows the acoustic device 100 and receiver 102 placed on opposite side of the plate 104. The actuator is thus employed in a through-transmission configuration in order to detect bulk defects from some complex perturbation in the fine-scale shape of the response signal received on the other side of the inspection part.

The AE signals measured from each interrogation of the inspection part 104 are processed by the signal processing chain before being compiled together (e.g. stored within an ER database) and presented to the data processing chain. The data processing chain describes the sequential algorithmic steps implemented in order to effect an automatic dimensional non-conformity or internal defect detection decision. Many different bespoke pattern recognition techniques could be realised to interpret the measured signal data.

FIG. 11 is a schematic illustration that shows one simple example of the generalised data processing stages that could implement a signal classification scheme. The data processing hardware shown in FIG. 11 comprises a time gating unit 110, a feature extraction unit 112, a data projection unit 114 and a signal classification unit 116. In summary, the arrangement of FIG. 11 essentially involves extracting characteristic features or data projections of the raw complex AE signals prior to either a supervised (e.g. ANN) or unsupervised classifier (e.g. clustering algorithm). This often extends beyond a simple Baysian statistical classifier due to an absence of reliable a priori class likelihood data and class conditional independence. The data processing stages shown in FIG. 11 are typically preceded by the signal processing stages described above with reference to FIG. 8.

After performing preliminary time gating (i.e. using time gating unit 10) on each of the AE signals stored for inclusion in the inspection decision, the first stage in the signal classification process involves using the feature extraction unit 112 to extract a suitable n-dimensional signal feature vector characterising each input signal from which classification decisions are derived. Selection of an appropriate feature vector is important, although some scenarios exist in which the raw AE signals are interpreted more directly within the classifier. An optimal signal feature vector will robustly characterise each input signal so as to discriminate between defined classes (e.g. a surface defect class, a sub-surface defect class), whilst retaining good generality for signals from identical conformal parts (e.g. an internally conformal class). The most obvious signal features that can be utilised within the data processing in order to automatically gauge or compare the external form of inspection parts directly from surface wave actuations across the inspection surface is the relative or absolute time of flight or wave speed data from across the array.

As described above with reference to FIG. 8, the absolute TOA or relative TDOA estimations can be performed in the signal processing chain and can be parsed into the data processing along with the raw AE signals. Compiling such wave speed data from spatially distributed multi-channel acquisition induced by only a modest number of actuation nodes actually provides a rich data stream for an effective form gauging method that could be based simply upon detecting unexplained deviations in the temporal feature data or a multivariate correlation technique (e.g. PCA).

The signal classification unit 116 provides acousto-ultrasonic signal classification for automatic defect detection. This can involve detecting potentially quite subtle modal perturbations in the received actuation signal (i.e. frequency, amplitude or phase shifts) and different inspection tasks may involve the extraction of more tailored feature vectors. Signal features that may be used for automatic defect detection can incorporate various common AE signal indicators such as rise-time, ring-down duration, counts or energy related features (e.g. MARSE, RMS Voltage etc.). However, several other features can also be included. Autoregressive model coefficients describing the fine-scale AE signal shape are quite effective discriminators and spectral parameters, as used in many audio signal classification applications (e.g. spectral peaks in fft or stft) can be potentially useful, especially as time-frequency transforms (Gabor spectrogram) can sometimes resolve and visualise separate fast and dispersive guided wave modes. However, such spectral features can have limitations for robust and incisive classification of acousto-ultrasonic signals due to stochastic complexity in the signal structure and the colouring effects of the AE sensor frequency response. Therefore, wavelet decomposition coefficients using a suitable mother basis function and statistical parameters describing the signal amplitude distribution can conveniently be included for pattern recognition (e.g. kurtosis, KS statistic). Also, it is highlighted that the restricted bandwidth and phase invariance observed within the AE response from the actuator indicate that zero-crossing encoding techniques are also powerful signal features that could be employed within the data processing algorithm (e.g. TESPAR).

The selected feature vector for each pattern recognition task addressed within the data processing chain will typically be task and inspection part specific. That is, an optimal feature vector for gauging weld integrity in a steel billet may well differ from a feature vector most suited to detecting de-lamination in an additively manufactured part. The data processing scheme may thus comprise iterative or adaptive processes by which feature vectors can be tailored or evolved from calibration data derived from actuation measurements taken across any inspection part or surface of interest, including the optimisation of suitable characterisation of any gold standard part or parts. Such feature vector calibration may effectively result in deriving optimal class labelled training data within any form of supervised learning classifier employed within the data processing (e.g. a backprop hidden-layer ANN). However, an unsupervised classification technique could alternatively be employed to naturally group similar parts of features more effectively without direct use of training data (e.g. k-means or hierarchical clustering). The feature vector used within the data processing chain preferably has the minimum number of dimensions to achieve the required classification task. This is because classification becomes computational difficult if the feature vector space is too large (e.g. it would require unrealistically large training sets as described by the curse of dimensionality resulting in an under-trained classifier). One such high dimensional case within the data processing scheme would occur if the feature vector became the full raw AE signal data sample stream. Therefore, various data projection methods may be employed by the data projection unit 114 to dimensionally reduce or optimise the data used within the subsequent classification performed by the signal classification unit 116 without loss of useful information.

One data projection method that may be employed by the data projection unit 114 is Principle Component Analysis (PCA). PCA involves projecting the n-dimensional feature vector data cloud into a lower dimensional sub-space (i.e. a linear combination/weighted eigenvalues of principle components eigenvectors). This has the added benefit that the classification process can be visualised within a scatter plot when three or less principle components are selected to represent the input data.

Referring to FIGS. 12(a) and 12(b), the concept of part classification using PCA will be described.

FIG. 12(a) shows a received AE signal measured from actuation of the snap-though buckling actuator on an additively manufactured part. The signal of FIG. 12(a) is analysed to infer whether a common defect (e.g. delamination) is present within the part. Referring to FIG. 12(b), a training set is derived from raw AE signals projected onto a first principle component Xi(PC1) and a second principle components Xi(PC2). A first set 124 is shown that arises from parts with no defects, a second set 126 relates to parts with sub-surface defect and a third set 128 relates to parts with surface defects. The supervised learning classifier, defined in this PCA projection by the first decision surface 120 and the second decision surface 122, indicates that the inspected part (i.e. point 130) has no defect and conforms to the manufacturing specification. In addition to such a projection technique that finds bases of maximum variance, other techniques could be used. For example, other linear dimensional reduction approaches could be used that attempt to find a projection that maximises the separation between classes (i.e. Linear discriminant analysis). A multivariate projection method, such as Independent Component Analysis (ICA), could also be used. ICA projects the measured data to non-orthogonal components that are most statistically independent. This could provide a very powerful and relevant pre-processing method within the data processing.

The time-synchronised responses to actuations that are measured at each array node across the inspection part can be modelled as a weighted combination or convolutive mixture of each of the independent AE sources excited by the actuation on the inspection surface. An effective signal processing technique for separating such sources may be used within the data processing. This may be implemented in a similar way to how ICA effectively separates useful EEG signals or the audio cocktail party problem. That is, the convolved versions of the actuation response measured at each of n-synchronous AE sensor nodes could easily mask useful classification information (e.g. due to interface reverberation) that could be useful if adequately unmixed. Although the technique assumes a level of non-Gaussianity and is fundamentally limited to de-convolving only the same number of mixed sources as there are enabled sensors, the method could facilitate improved inspection results. In particular, the technique could increase one or more of; (i) wave speed estimation accuracy (e.g. improved form gauging), (ii) probability of defect detection by significant SNR gain on one or more channels (iii) location accuracy of internal excited defects. This blind source separation may be performed using, for example, the known FastICA algorithm.

As discussed, feature vector projections from each measured input signal(s) is presented to an appropriate statistical or artificial neural classifier. The classifier may either effect an automatic classification decision based upon supervised or unsupervised learning. Various methods can be employed to invoke the signal classification decision. A well trained artificial neural network (non-linear supervised classification) may be implemented for specific classification tasks, although this comes with a risk that training lacks generality across inspection tasks and is not transparent. Therefore, supervised learning classifiers based upon well-known and robust statistical rule frameworks (e.g. LDA, Baysian) would typically be preferred. In such cases, the available training or feature vector calibration may result in large amounts of class labelled learning data being stored within a formal ER database that efficiently returns dataset during the classification process. However, it is noted that such a classification database relies on acquiring and storing possibly difficult to acquire, un-validated or impractical classifier training or feature vector calibration truth data. For example, it would often be impractical in terms of cost and time for a user to measure and compile suitably robust training data as it would require several manufactured parts with simulated, artificially seeded or validated internal defects to be measured or calibrated.

An example of a preferred unsupervised classification approach will now be described in detail. In particular, it has been found that the multivariate “clustering” technique can provide robust and practical classification for inspections. It has been found that both hierarchical and non-hierarchical clustering algorithms can be applied to interpret measured acoustic emission data. A non-hierarchical K-means approach involves predetermining the number of clusters and defining cluster seed points to group input signals within a pre-specified distance. Such procedures can be used for classification but require a certain sample size and are dependent upon selecting good seed points within classes. Such a non-hierarchical approach can thus be unstable in certain circumstances.

The use of hierarchical clustering techniques has been found to offer important advantages. For example, it does not require the number of classes to be defined before classification. It also works well with small sample sets and it portrays the complete tree-like structure of similarity between measurements that can be usefully visualised within an agglomerative dendrogram plot. It is highlighted that such simple hierarchical clustering is an extremely useful data processing method for automatic conformity gauging or natural grouping of both high and low volumes of inspection parts or identical features inspected on large individual parts.

Hierarchical clustering involves two sequential stages. The first stage is the “similarity” stage. In this first stage, a measure of correlation or closeness such as the Euclidean distance between every pair of signal feature vectors is determined within the similarity matrix. The Euclidean distance is defined by the distance between objects i and j within n-dimensional space by equation (1):

$$Dij = {( {\sum }_{k = 1}^{N} {( {X}_{ik} - {X}_{jk} )}^{2} )}^{\frac{1}{2}} \qquad ( 1 )$$

where Xik is the value of the kth variable for the Ith entity.

The second stage is the “linkage” stage. In this second stage a series of clusters of increasing size are made using the information in the similarity matrix, starting with the closest two signal objects, until all the objects are linked together in a hierarchical tree. A number of methods may be used accomplish this clustering, including single-linkage, complete linkage, average linkage, Ward's method and the centroid method. It is noted that single-linkage clustering may be susceptible to undesirable early combinations involving class outliers leading to spurious clustering chains.

Referring to FIGS. 13(a) and (b), an example is given of how the above described snap-through buckling actuator and associated signal processing techniques can be applied for non-destructive inspections. In particular, FIG. 13(a) shows a complex geometry isotropic steel disk 140 incorporating forty nominally identical welded rivets 142. Instead of welded rivets 142, the disk 140 could alternatively comprise forty screws. The rivets 142 are probed in-situ by an acoustic device 144 comprising a snap-through buckling actuator. The acoustic device 144 is carried by a moveable mechanical arm 146 which may form part of an automated platform, such as a CMM. A single receiving AE sensor 148 is fixed to the disk 140 in a central location so as to be equidistant to each feature.

In use, the moveable mechanical arm 146 sequentially positions the acoustic device 144 at each of the scan points 150. The scan points 150 are located a short radial distance from each rivet 142 on the outer side of the circumference of the circle of rivets 142. The snap-through buckling actuator of the acoustic device 144 is actuated at each scan point 150 and the acoustic signal received by the sensor 148 is collected and analysed (e.g. using the signal processing and data processing techniques described above). It is noted that such a scan inspection can be performed in a much shorter time than manual inspection of each feature.

The repeatable actuator response signals arising from transmission across each transmission path are passed to an unsupervised clustering algorithm. Any of the signals that are in any way different from normal signals that characteristically define an acceptable joint or bond integrity (e.g. welds, rivets, screws) across the inspection part can thus be identified. This information can be usefully presented to the user as a dendrogram. A plot of the results of the forty measurements is shown in FIG. 13(b). In this example, it can be surmised that the final ten rivets have not been tightened properly, although there is no obvious visual evidence of this.

Referring to FIG. 14, a further example will be described that comprises conformity gauging of eight identical complex geometry parts 170a-170h (collectively referred to as parts 170) placed on a CMM bed 172. Each of the parts 170 is held on the bed by a fixture. The arm 173 of a CMM carries an acoustic device 174 comprising a snap-through buckling actuator. Four receiving AE sensors 178 (only some are illustrated) are attached to substantially the same location on each of the parts 170 (e.g. by using the same fixturing configuration for each of the parts).

Measurements are conducted using time-synchronised four-channel AE measurement as described above. An input control signal is supplied from the CMM to the acoustic measurement hardware to enable only the relevant group of four sensor signal to be used for digital acquisition. The accurate application of a sparse number of actuations across each of the part 170 at substantially the same equivalent transmit nodes with substantially equivalent measurement nodes fixtured, useful conformity gauging or defect detection can be conducted. In this case, up to four convolutive sources may be temporally resolved and promoted by induced SNR gain using the FastICA algorithm. As shown in FIG. 14, the inspection result from this example suggests that the dimensional form (or internal form) of the 6th part is significantly different to the others. By adopting a multi-channel time of flight signal feature vector, non-conformal shape conditions that may be difficult to observe visually by eye or even using a camera or fringe probe (e.g. incorporating remote enclosed shape defects), may be diagnosed.

FIG. 15 depicts a similar automatic de-lamination detection scenario within an additively manufactured inspection part 200. The part 200 comprises twelve identical small diameter bore-holes 202. A receiver 204 is placed at the lower end of each hole 202 and a selected receiver signal is passed to the signal and data processing stages. The arm 206 of a CMM carries an acoustic device 208 comprising a snap-through buckling actuator.

The acoustic device 208 is actuated at the upper entrance of each hole in turn. During each actuation, the relevant receiver 204 is activated and the acoustic signal analysed. This sequential single channel AE data is used with an acousto-ultrasonic pattern recognition method to assess if any hole exhibit a delamination defect. The pattern recognition may be performed using unsupervised clustering. Alternatively, the pattern may be explicitly classified by a well qualified supervised classifier. It is noted that this type of interrogation may be a useful application that exploits circumferential leaky creeping waves (i.e. often referred to whispering gallery waves) to detect surface cracks or delaminations remotely down very small diameter holes. This technique is especially beneficial where poor light conditions may prevent time efficient inspection by a narrow-field-of-view camera or boroscope or where the holes exhibit curved features (i.e. they are not straight drilled holes).

A further sparse actuation application of the above acoustic device is the improved inspection of individual bolt or screw fasteners. This may be performed using an automated platform, such as the CMM described above. Alternatively, the platform could be a semi-automated XY-scanner, a mechanical arm or a crawler vehicle. In such automated inspection cases, the snap-through buckling actuator would preferably be loaded against the bolt head in a reliable and relatively repeatable fashion. In such cases, a single receiver statically attached to the structure at one location could be used to facilitate in-service inspection of several bolts in the vicinity.

Inspection tasks are, however, more typically associated with in-situ instantaneous or scheduled maintenance inspections of safety-critical or high-value mechanical structures involving a large number of bolted assemblies. In particular, such inspections may be performed to ensure that the mechanical integrity or clamping tension within the bolt and the mating bodies is maintained or to detect any incipient fault condition that could lead to sudden joint failure, such as corrosion cracking or loosening. Examples of such applications include safety critical bolts in aerospace structures such as landing gear mechanisms or the bolts distributed across suspension bridges, oil-rig platforms, marine vessels, containers etc. Equally, all manner of flange bolts within oil or gas pipelines, the gasketted flange bolts in power stations, petrochemical vessels, nuclear reactors or heat-exchangers all require that a uniform loading around the flange or joint structure is maintained in order to avoid any costly or dangerous liquid or gas leaks.

The above described snap-through buckling actuator may, in one embodiment, be incorporated into a handheld device that can be manually loaded onto the bolt or screw head. One or more receiving sensors may be temporarily attached (i.e. acoustically coupled) to the bolt or to surrounding components. In this manner, a stand-alone, self-contained compact and light-weight device may be provided. A variety of mechanical assemblies (e.g. a linear motion fly/toggle press) may be adapted to allow the snap-through actuator to be repeatedly loaded on to the bolt/screw head along a predefine linear vector. This allows spot check inspections of any individual bolt assemblies to be conducted without significant setup procedures.

It should be noted that various techniques have been used previously to for in-situ inspection of bolts and screws. These include direct torque measurements, which may comprise integrating strain gauges into fastener structures. Conventional pulse-echo ultrasonic thickness measurement probe have also been used to measure elongation with the bolt from its unloaded tension to its preload tension. Such pulse-echo methods suffer from several disadvantages. In particular, length measurements require sound speed calibration and the bolt length must also be measured before and after being torqued up to the required pre-load tension. The pulse-echo method affects only a relative measurement of the bolt length and does not assess or inspect the actual bolt thread to mating material interface or the effective thread engagement. The transducers required for such ultrasonic pulse echo inspections are also generally of a size that make it difficult to acoustically couple to a range of real bolt heads consistently, without significant levels of preparation to the bolt head (e.g. removing paint/rust and/or applying a couplant) to the surface prior to making the inspection. There may also be significant absorption of the ultrasound frequency at which such measurements are performed, resulting in a low SNR and/or undetectable echo from the distal end of the bolt.

In contrast, the snap-through buckling actuator described herein generates a repeatable point source in phase and amplitude within the lower ultrasonic region (e.g. 0.02-2 MHz). This can be used for both calibrated and uncalibrated assessment of bolt tension (based upon either absolute or relative acoustic energy measurements) or for more effective bolt elongation measurement. In the former case, a more informative and unique assessment of the bolt thread engagement and/or the clamping force can be made. In the latter case, absolute or relative through-transmission time-of-flight measurements across the bolt can provide an accurate measurement of bolt elongation or tension more easily and reliably and for a wider range of bolts than can be achieved using conventional pulse echo methods. These techniques will now be described in more detail with reference to FIGS. 16(a)-(b), 17(a)-(b) and 18(a)-(d).

FIG. 16(a) depicts a screw 220 that holds an upper plate 222 against a lower plate 224. A first acoustic sensor 226 is temporarily attached to the side of the screw head and/or a second sensor 228 is temporarily attached to the bottom side of the lower plate 224. A snap-through buckling actuator 230 is also shown engaged with the top of the screw and will generate an ultrasound pulse when appropriately loaded into the screw head.

FIG. 16(b) shows the acoustic signal energy (illustrated as dots 232) for a successive train of actuations measured received by the first acoustic sensor 226 as a function of bolt tension. The figure also shows the acoustic signal energy (illustrated as crosses 234) for a successive train of actuations measured received by the second acoustic sensor 228 as a function of bolt tension. The acoustic signal energy may be measured in a number of ways, for example peak voltage, integrated or RMS energy.

The energy of the signal received by the first acoustic sensor 226 can be seen to decrease as the screw is tightened up (i.e. as the torque and tension is increased). This suggests that the screw assembly acts as a more effective acoustic energy ‘sink’ as the tension and clamping force is increased. This is also reflected by the corresponding increase in the acoustic energy received by the second acoustic sensor 228. It is thus possible to measure or compare the effective screw tension, estimate the actual clamping force between mating parts and/or detect fault conditions such as debris or corrosion within the threads or any unscheduled loosening. Moreover, by comparing other AE signal parameters or signal features extracted from the measured actuator response, it is also possible that the thread engagement can be assessed more directly (e.g. using spectral or AR modelling coefficients). Any significant loss of tension or any significant loosening in the bolt can thus be detected more easily over the service life of the bolt.

Referring to FIGS. 17(a) and 17(b), it will now be described how it is possible to measure the absolute tension in bolt fastener assemblies using time of flight measurements using a through-transmission configuration employing a snap-through buckling actuator. This method uses a similar principle to pulse-echo ultrasonic thickness measurements as it estimates the bolt length directly, but as described below it has a number of advantages.

FIG. 17(a) shows a bolt 250 having a bolt head 252 and a threaded shaft 254. A nut 256 is screwed onto the distal end of the threaded shaft 254. The bolt 250 secures plates 258 and 260 together. An acoustic device 262 comprising a snap-through buckling actuator is shown pressed against a central point on the top of the bolt head 252. A first AE sensor 264 is attached to the top of the bolt head 252 and a second AE sensor 266 is attached to the lower end of the nut 256.

FIG. 17(b) shows a bolt 290 having a bolt head 292 and a partially threaded shaft 294. A nut 296 is screwed onto the distal end of the threaded shaft 294. The bolt 290 secures plates 298 and 300 together. An acoustic device 302 comprising a snap-through buckling actuator is shown pressed against a central point on the top of the bolt head 292. A first AE sensor 304 is attached to the side of the bolt head 292 and a second AE sensor 306 is attached to the lower end of the nut 296.

The arrangements shown in FIGS. 17(a) and 17(b) allow bolt length to be determined from the relative time-of-flight measurement of the actuated waveform at each of the two sensor locations (i.e. using the sensors placed at the top and bottom of the bolts). This technique, like known pulse-echo based methods, does require some form of sound speed calibration but use of the snap-through buckling actuator as the acoustic source has a number of advantages over prior pulse-echo bases systems.

In particular, ultrasonic excitation on the bolt head is more effective when using the snap-through buckling actuator because it does not require a sizable area of the bolt head to be specially prepared (e.g. smoothed and cleaned) to couple to a piezo-electric pulse echo transducer. There is also no requirement for an ultrasonic coupling gel or liquid to be applied, as the point source of the snap-through buckling actuator penetrates through rough or painted inspection surfaces. It is also noted that many types of commercially available bolts have symbols machined into the bolt head (e.g. identifiers), making a significant proportion of the head quite rough and less suited to conforming to a traditional (e.g. piezo based) ultrasonic pulse-echo probe. Furthermore, actuation of the snap-through buckling actuator generates sound in the low ultrasonic band (e.g. 100 kHz-2 MHz). An inherently higher signal-to-noise (SNR) inspection signal is thus produced that can be used across a wider range of larger or longer bolt fastener assemblies constructed from acoustically highly attenuating materials (e.g. steel billets).

A bolt inspection system comprising a snap-through buckling actuator also requires less complex and potentially lower cost instrumentation than prior piezo based inspection systems. The same acoustic device (i.e. the same snap-through buckling actuator) can be triggered at the centre of any type or size of bolt head. In contrast, conventional piezo based pulse echo bolt tension systems often require a user to select from a suite of transducers with differing operating frequencies and wear plate diameters to optimise pulse echo measurements. A snap-through buckling actuator, unlike a piezo driven device, also requires no transmit voltage generation or pulser electronics to drive the transducer. Furthermore, the much lower measurement band of interest (e.g. 100 kHz to 2 MHz) allows the use of lower cost and complexity receiving sensors and digital acquisition electronics compared with operation in the 1-20 MHz pulse echo regime.

As will now be described with reference to FIG. 18, the above described benefits provided by a snap-through buckling actuator method of bolt inspection allow a low cost hand-held probe to be provided. FIGS. 18(a) to (d) show four different views of a hand-held bolt inspection probe 400. FIGS. 18(a) and 18(b) are top and bottom views respectively. FIG. 18(c) is a side view of the probe whilst FIG. 18(d) shows a section through the plane E-E shown in FIG. 18(c). The probe 400 comprises a bolt head adapter 401, an acoustic receiver 402, a snap-through buckling actuator 403 attached to a base 404, an instrument body 405, a plunger shaft 406, a return spring 407, a push pad 408 and a guide bush 409. Associated processing electronics are not illustrated in the figure. In use, the inspection probe is engaged with a bolt head and the tip of the snap-through buckling actuator 403 is loaded against the bolt head with enough force to be actuated. The resulting ultrasonic pulse is transmitted into the bolt and detected by the acoustic receiver 402. As described above, the received signal can be processed as required to provide a measure of bolt tension, bolt condition etc.

In addition to the sparse actuation inspection methods described above, higher resolution imaging is also possible using the snap-through buckling actuator. In particular, a higher concentration of actuation events can be exploited across an inspection part to construct some form of surface or sub-surface defect imagery. The snap-through buckling actuator has been found to lend itself to very fast high resolution scanning, because it does not have to continually conform or acoustically couple to a surface during the scanning process. Examples of such high resolution scanning will now be described with reference to FIGS. 19 and 20(a)-(d).

Lamb wave tomography is one example of a high resolution NDT approach that could be used with a snap-through buckling actuator. Lamb wave tomography uses variations in wave speed measurement, derived from phase velocity estimation across the part, to construct sub-surface or surface imagery in order to spatially isolate discontinuity defects (cracks or delamination). To collect a suitable distribution of spatially shifted transmit-receive (Tx-Rx) wave speed measurements for an adequate resolution image to be rendered would require one or more receiving sensors to be attached to the automation platform along with the actuator. Alternatively, computerised tomography (CT) lamb wave imagery of possible sub-surface defects could be implemented by coupling a large array of conformal receiving sensors to the surface of the complex geometry part, forming the perimeter of the inspection area within which the actuator would be scanned.

Although the above described Lamb wave imaging arrangements could be used, it has been found that a time difference of arrival (TDOA) technique can be advantageously employed. In particular, contour maps of constant TDOA estimations between sensor pairs across a complex part can be generated in order to reveal any unpredictable contour features or sharp gradients that could be directly attributed to the presence of a sub-surface defect. Such a technique benefits from the ability of the snap-through buckling actuator to be formed with a small tip to allow omni-directional wave propagation and is less complex to implement than an Lamb wave imaging arrangement.

Referring to FIG. 19, the high resolution imaging of a complex part will be described. In particular, a gear wheel part 450 is illustrated. The gear wheel part 450 is mounted to the bed of a CMM and a moveable arm 452 of the CMM holds an acoustic device 454 that comprises a snap-through buckling actuator. Four AE sensors 456a, 456b, 456c and 456d (collectively termed receivers 456) are evenly spaced from each other on the gear wheel part 450.

In use, the acoustic device 454 is brought into contact with a plurality of contact points 458 on the surface of the part 450. These contact points 458 form a high granularity regular pattern or regular grid. The snap-through buckling actuator is actuated at each point on the grid (i.e. at each grid node) and the AE response is measured by each of the four synchronous AE sensors 456. From this multi-channel data, contours of equal waveform arrival time for each sensor pair in the array are constructed and projected on to the inspection surface geometry, as illustrated by the contour lines 460 that are superimposed on the part 450. Importantly, the contour mapping calibration technique allows a level of spatial interpolation (e.g. linear interpolation) where missing actuation nodes can be compensated for. The TDOA contour maps generated from the signals of sensor pairs thus represents a useful technique for imaging and quickly identifying sub-surface or surface defects. Such contour maps may then allow a different scanning strategy to be adopted (e.g. by altering the actuation scan pattern or actuation pitch) depending on time delay data calculated during the scan.

The TDOA contour mapping or “Delta-T” method thus allows any contour kinks or local gradient features that cannot be attributed to known internal or external geometry features (e.g. holes, undulating features) to be visualised and interpreted as a defect. Confidence in such a detection increases, and/or more accurate sizing can be estimated, where such kinks or severe gradients detection between different sensor pairs spatially overlap on the part (i.e. geometric combining).

The above described Delta-T method thus exploits the inherently more repeatable (i.e. in phase and amplitude) ultrasound waveform produced by the snap-through buckling actuator in combination with the positioning accuracy that can be obtained using an automation platform such as a CMM. In most case, there is no requirement for an averaging technique to be used to reduce variability. Furthermore, it is a scan inspection method using high quality temporal calibration data to actually image sub-surface defects at a resolution that can be selected or adapted during the scan and that can exploit more accurate TDOA estimation to potentially allow more data interpolation and therefore fewer required scan nodes. This facilitates an even faster scanning method generating accurate defect indicating contours that also inherently provide defect location and sizing accuracy. In other words, such TDOA measurements provide informative spatial samples of relative wavespeed in the orientation of each sensor pair. Every multi-channel measurement from actuation across the grid nodes is potentially more relevant to the existence of internal defects suggesting that scan patterns can be quickly altered and intelligently focussed on locations exhibiting evidence of a defect. This is in contrast to automated pulse-echo scanning where measurements are laterally independent across the inspection surface and, even where the pitch granularity is lowered by a synthetic aperture focussing technique (SAFT), only high resolution periodically sampled scanning ensures complete coverage.

The automated DeltaT defect detection method described above thus provides a time-efficient scanning method to coarsely locate potentially defective areas across the inspection part. The DeltaT defect detection method may form a preliminary scan that is followed, if necessary, by an inspection using a high resolution ultrasound imaging probe that operates at a slower scan speeds (e.g. a commercially available 5 MHz pulse echo piezo-electric based probe for internal crack detection).

Although TDOA contour mapping is described above using apparatus in which the acoustic device is carried by a CMM, the technique can also be used for a variety of alternative application. For example, an alternative application for the TDOA contour mapping method is in time-efficient corrosion or porosity mapping of pipes (e.g. coolant pipes in nuclear reactors or the like). In this case, an automation platform (e.g. a mechanical arm, a crawling robot or an XY-scanner frame) may be used to manoeuvre the acoustic actuator over the external surface of the pipe. Due to the simple homogenous, isotropic plate-like construction of many pipes a smooth TDOA hyperbolae would be expected and any deviations from such a shape would suggest internal corrosion. However, it should be noted that the DeltaT defect detection method is not confined to simple isotropic materials. Surface defects (e.g. impacts) and subsurface defects (e.g. delaminations) can also be visualised in various anisotropic fibre metal laminates (e.g. GLARE aerospace structures) using this high resolution method.

A further use of the TDOA contour mapping technique is the detection, location and/or approximate sizing of delaminations in composite materials (e.g. carbon-fibre matrix). For example, large wind and wave power turbine blades are often constructed by adhesion between a thin outer composite layer and a thicker internal foam. In this case, delamination or air-pocket voids within the epoxy glue layer at the composite-foam interface require detection during the manufacturing process. In addition to applying the TDOA mapping method to provide a high resolution scan, spectral analysis may also be applied to the high resolution scan data from individual channels. In this case, any changes in the averaged or time-evolving frequency spectra of the actuated signal may be compiled to reveal an informative high resolution C-scan revealing changes in the blade structure (e.g. to detect delamination areas). Similarly, the airborne response to the scanned snap-through buckling actuator can also be measured using a suitable wideband microphone positioned either statically in the vicinity of the actuations or moved along with the actuator (e.g. a condenser microphone operating in the frequency range of 20-100 Khz). This airborne response application is analogous to tap-testing where an experienced technician listens to the audible response to light tapping across the blade outer surface, but instead provides an automated and highly repeatable tap-testing NDT method

An empirical TDOA contour calibration map may be generated for complex geometry parts, or large composite structure, with numerous inhomogeneities, interfaces (e.g. stringer joints) and composite components (e.g. marine diesel engine). Such maps are typically generated most effectively using a precision metrology platform to accurately locate the acoustic emission source. Such a map may be measured and stored in a database during the manufacturing process. The map may then be used to facilitate more accurate fault location within any subsequent online AE condition monitoring system (e.g. for monitoring impacts across an aircraft fuselage, rubbing within a diesel engine etc), during scheduled NDT maintenance during the parts lifecycle (e.g. by comparisons with the TDOA data during manufacture), or for more accurate diagnosis of fault conditions.

Referring to FIGS. 20(a)-20(c), a high resolution Lamb wave imaging method will be described. The technique provides useful C-scan defect images and a way of visualizing time-evolving Lamb wave propagation within anisotropic composite plates is also described.

FIG. 20(a) shows a single AE sensor 500 statically mounted on a complex composite plate inspection part 502. An acoustic device 504 comprising a snap-though buckling acoustic actuator is carried by the arm 506 of a CMM.

In use, the acoustic device 504 is scanned at a very high x and y resolution across a region 508 on the surface. An image construction technique is used that assumes the propagation path between the moving actuator device 504 and the static receiver 500 is equivalent to that in which they are reversed (i.e. the receiver is being scanned whilst the actuation is stationary). It is also necessary for the AE acquisition to be time-synchronised for every actuator node. That is, the acquisition t=0 point has to been synchronised with the exact time that the actuator triggers. This could be accomplished, for example, by placing an additional synchronous AE sensor on the actuation buckling plate and performing a time difference or time delay estimation (e.g. using cross-correlation).

At the end of the automated scan pattern, the raw AE data from each scan point is compiled such that the data stream from each scan point acts like a single pixel within a 2D image. By scrolling through each successive time synchronised data sample from this 2D image, each representing a snap shot of the Lamb wave activity within the plate (as if centred about the single AE sensor 500), a time-evolving movie of the Lamb wave propagation can be observed. This visualisation technique could be adapted for effective defect detection (e.g. diffractive effects around a defect would be pronounced within the imagery, allowing improved detection performance from temporal image integration). Moreover, as illustrated in the plot of FIGS. 20(b) to 20(c), A0 and S0 modes can be identified clearly within such time-evolving imagery (i.e. the faster S0 mode is highly orientation dependent whereas the slower A0 mode is more constant). A method for crystal orientation estimation in composite or single-crystal alloys is thus provided.

In cases where suitable sub-surface C-scan images can be compiled (e.g. a surface projected C-scan) that show defect features or unexplained discontinuities as contrasting colour intensities or on a grey-scale display, it is possible to implement an appropriate automatic detection algorithm. This may be based within a statistical framework (or null-hypothesis testing) to distinguish between a defect and background noise. As the a priori probability functions for noise and defect are usually unknown, defining a detection decision rule based upon a Baysian classifier may not be possible. Instead, a constant false alarm rate CFAR detector based upon Neyman-Pearson criteria may be implemented, in which the probability of detection is optimised for an acceptable false alarm rate.

Referring next to FIGS. 21 to 27, it will be described how the acoustic device of the present invention can be embedded in, or attached to, an object for use in condition monitoring applications or the like. In particular, the robust, compact and cost-effective snap-through buckling actuators may be retro-fitted onto existing mechanical structures using bespoke mechanical mounting fixtures or spot-welded directly into the structure at advantageous locations. Equally, for certain high-value mechanical assets (e.g. additively manufactured complex geometry metallic components), the acoustic actuators can be integrally designed and directly built into the mechanical structure during the manufacturing process. This enables in-service condition monitoring throughout the entire life time of the asset.

A plurality of snap-through buckling actuators may be provided for monitoring applications. For example, a distributed array of acoustic actuators can be either triggered independently at entirely random or deterministic discrete time instances by an appropriate mechanical excitation force. In the former case, intermittent actuation events are caused by the forces imparted through any natural vibration, strain or relative movement within the structure or directly by the forces associated with naturally occurring environmental effects (e.g. wind, waves). In the latter case, more predictable inspection waveforms are generated by actuations induced directly by forces from some scheduled mechanical movement within the structure (e.g. a moving train or rotating bearing) or equally by some other externally applied actuation force (e.g. manually loading or application of a magnetic field). In either case, any variability exhibited by the driving force vector applied during the actuation has little or no perturbing effect upon the generated inspection waveform generated from the snap-through actuation. That is, the snap-through actuators act as effective low to high frequency step-up converters whereby variable strain or loading forces are converted into predictable high-velocity snap-through buckling motion that induce repeatable and useful inspection waveforms.

An object being monitored can also include one or more acoustic receivers. These may be embedded in, or attached to, the object. An array of such acoustic receivers may be provided that are distributed across the object. As explained above, each of the enabled receiver nodes convert the incident acoustic response into proportional electrical signals. These signals may then be processed, as described in more detail above, to monitor the instantaneous or ongoing online health condition of the object being monitored. This diagnosis may include external and internal dimensional form gauging (e.g. thickness gauging), the sudden occurrence of surface holes in aerospace structures, or the automated detection and location of internal defects (e.g. stress corrosion cracking, corrosion, porosity), fatigue deformation or any more general loss in structural integrity (e.g. loosening of welded or bolted components).

The signals received by the acoustic receivers may be processed in a variety of different ways, depending on the application. For example, the signals at individual nodes (e.g. isolated transmit-receive sensor pairs) may be analysed. Alternatively, time-synchronised measurement of the actuation response at several receiving sensor nodes surrounding an actuator node may be used with some form of time-delay estimation in order to spatially locate each actuated source within the structure or part. Instantaneous condition diagnosis can be based entirely upon isolated short-term data processing and analysis of individual actuation signals received across the sensing array (e.g. internal crack or delamination detection based upon detection of reflected or diffracted waves across the defect). However, it may equally be based upon direct waveform comparison, trend or time series analysis compiled from a succession of acoustic measurements made within the structure over longer time periods (e.g. months or years). In both cases, robust and reliable condition monitoring is provided that is capable of detecting the early stages of mechanical distress across many types of structural asset or moving machinery or heavy plant.

It should be noted here that known Acoustic Emissions (AE) condition monitoring systems are typically arranged to passively listen to mechanical structures in order to detect and analyse any of the complex wideband waveforms that are generated during significant plastic deformation conditions such as crack propagation or some other mechanical distress condition (e.g. frictional rubbing, impacts, etc.). However, such events happen intermittently and purely passive detection of any periodically changing mechanical condition (e.g. cyclic loading) can be unreliable due to low signal-to-noise ratios and/or the Kaiser effect. In contrast, the more regular and predictable stress wave inspection waveforms generated by the snap-through buckling actuator provide inherently more reliable inspection data induced by more frequent actuations and probing signals.

Additionally, the acoustic inspection waveforms generated by an array of embedded snap-through buckling actuators (e.g. manufactured in the same material and attached directly to the object or structure being monitored) also have the advantage that they do not incur any additional attenuation, perturbation or mode conversion before propagating through the mechanical asset from weld or other joint interfaces. This means that the inspection signals generated will incur less inherent variability and are more easily controlled and interpreted. It can also result in a more robust and reliable inspection system less likely to require costly maintenance. The acoustic signals can also be generated in locations across the structure under most mechanical stress. This allows more deterministic inspection data in areas of concentrated stress or greatest structural movement and hence more reliable detection diagnosis and location of faults.

A further advantage is that non-linear snap-through bucking members can be provided as part of an efficient energy-harvesting mechanism. For example, the snap-through buckling actuator may be either bonded directly, or placed adjacent to, a piezo-based energy harvesting element connected to appropriate electrical charge storage and power generation electronics. This vibration energy harvesting method is useful in the condition monitoring of mechanical assets where electrical power is not readily available (e.g. across aerospace structures) or where alternative energy harvesting methods are impractical (e.g. solar).

Unlike prior self-powering ultrasonic or acoustic sensor network systems, the energy harvesting function of each snap-through buckling actuator only needs to accumulative enough electrical charge to power the receiver nodes and possibly a wireless data link. This arrangement is thus particularly suited to remote actuation and/or monitoring of objects where mechanical faults develop slowly and can be monitored over long periods of time. For long term asset condition monitoring applications where a higher concentration of sources are deployed and/or source actuations are induced at a high rate, the snap-through buckling actuators can be used directly to harvest power (i.e. electrical charge) that can be used to power the receiving system. This reduces the installation and/or maintenance costs associated with distributed power sources or batteries.

It should be noted that an extremely wide range of mechanical assets can be usefully inspected or more continually monitored using an acoustic device of the present invention. In general terms, such assets can be classed as static structures or dynamic structures. These different classes of structures will be described in more detail below.

Static structures are structures that are placed under stresses by stochastic or intermittent cyclic loading induced by conditions or events that can occur within their operating environment. Examples of safety-critical assets requiring long-term health monitoring include any type of steel girder, a pre-stressed concrete bridge or viaduct structure that is intermittently loaded by heavy vehicles or rail traffic or can be subjected to extreme weather conditions (e.g. high winds) that can induce increased vibration. In this example, fatigue cracks and/or corrosion can be detected. A further example is an oil-rig platform that is subjected to extreme weather conditions including high winds and waves that can cause fatigue cracking in the steel structure or welds, corrosion or loosening in bolted joints. Equally, all manner of oil and gas pipelines can be monitored. For example, oil and gas pipes are often very susceptible to corrosion that is difficult or costly to detect visually due to external wrapping/cladding around the pipe or visual evidence being on the internal surface of the pipe.

Dynamic structures comprise structures in which highly deterministic loading occurs due to deliberate or scheduled movements within or across the mechanical asset being monitored. An important example of such a dynamic mechanical asset that can be monitored is railway tracks. Dynamic mechanical structures may also be monitored that produce significant acoustic noise, such as online wind turbine asset monitoring, online rail inspection and in-service bearing inspection. Various aerospace structures can also be monitored; e.g. the landing gear mechanism of an aircraft. Is is also possible to monitor different types of rotating or reciprocal machinery, especially in large and/or slow rotating machinery where alternative acoustic non destructive testing methods are insensitive or impractical. Drilling assemblies are a further example of a dynamic structure that could be monitored.

The structures into which the snap-through buckling actuator may be embedded include, without limitation, bridges, pre-stressed concrete, wind turbine towers, rails, roller-coaster, rides, pipes (e.g. oil/gas pipelines), landing gear, aerospace structures, cranes, lifts, cable cars, excavators, robotic arms, joints, bearings, slow rotating machines (e.g. slow rotating bearing in wind turbines), engine blocks, sailing masts, underwater paddles etc. A number of specific condition monitoring examples will now be described in more detail, although it should be remembered that such examples are illustrative only.

Referring to FIG. 21, a snap-through buckling actuator 600 is shown welded to a part to be inspected 602. Actuation of the actuator 600 allows an acoustic pulse to be efficiently coupled into the part 602. The actuator 600 could be welded to the part 602 as part of a wire and additive manufacturing (WAAM) process. An acoustic receiver (not shown) could be attached to the part 602 at an appropriate location.

FIG. 22 illustrates the acoustic device comprising a snap-through buckling actuator 610 attached to two beams 612, 614 that are bolted together at a joint 616. Relative movement of the beams triggers the snap-through buckling actuator 610 thereby generating an acoustic pulse that is coupled into the beams 612, 614. One or more acoustic receivers (not shown) could be attached to the beams 612, 614 at appropriate locations.

FIG. 23 illustrates the use of a snap-through buckling actuator 620 and two receivers 622, 624 for monitoring a pipe 626 (e.g. an oil or gas pipe). This arrangement allows inspection of the pipe (e.g. for corrosion detection from detectable changes in across pipe attenuation), despite the outer layer of cladding 628.

FIG. 24 illustrates the use of a snap-through buckling actuator 630 and four receivers 632, 634, 636 and 638 on a steel beam support member 639. A processor 640 for analysing the received signals is also shown.

FIG. 25 shows three snap-through buckling actuators 650 attached to three vertical support wires 652 of a suspension bridge. The condition of the wires and their attachment to the upper member 654 and lower member 656 can then be monitored.

FIG. 26 shows a snap-through buckling actuator 670 attached to a rail track 672. An online railway inspection system can thus be provided comprising a plurality of such snap-through buckling actuators acting as through-transmission sources for in-situ NDI of rail tracks. Such an arrangement would be capable of the automatic detection of internal or surface cracks or broken rails. For example, a regularly spaced array of snap-through buckling actuators could be positioned along the track so that any passing train imparts sufficient compressional force or vibration to trigger the actuator thereby causing an interrogating structured AE source waveform (e.g. a low frequency Rayleigh wave mode) to propagate across the rail track interfaces and into the train wheel structure where it can be measured by a statically mounted array of one or more acoustic receivers. The wideband modulation and predictable waveform shape of the source facilitates reliable detection using a coherent processing techniques. The only additional signal processing stage required to pick out the interrogation waveforms from within potentially higher levels of background AE noise is a linear matched filter or replica correlator. In this example, only a simple mechanical frame is required to hold the actuator in place so that compression or vibration forces induced by every passing train causes it to trigger.

The rail monitoring system described above has the advantage that it would not require any expensive AE acquisition hardware to be distributed over the rail network. Furthermore, the actuators are robust, simple mechanical devices that are self-powered; e.g. using energy harvesting actuators or step-up vibration force converters. Also, the receiver system could be integrated into regular passenger trains operating across the rail network removing the need for track outages for specialised and time consuming inspections. Additionally, preliminary rail defect detection decisions automatically made by any individual train travelling across the network could be time stamped and spatially located. All such defect detection events from all trains carrying the receiver system could be combined within a central data fusion processor, thus improving overall inspection performance via well established information data fusion techniques (e.g. Baysian, Dempster-Shafer decision level fusion).

FIG. 27 illustrates a further example of how a plurality of snap-through buckling actuators 680 could be incorporated in aircraft landing gear. The actuators could be arranged to trigger on landing and/or take-off. In this manner, the condition of the landing gear structure could be regularly checked. Other parts of an aircraft subject to cyclic loading forces (ribs, Stringer joints, wings etc) could be monitored in a similar way.

Referring to FIGS. 28-30, it will be described how the device of the present invention can be used for assessing medical implants. For example, the device could be used to infer information concerning the condition of the implant, the implant to bone interface and/or the implant stability. Receivers may either be permanently embedded within the implant or temporarily attached (e.g. to the external skin surface in the vicinity of the implant) when required.

The device may be applied to several types of medical implant and can be useful at all stages of the implant lifecycle. For example, it may be useful to the surgeon during the implant installation operation performed under local or general anaesthetic. In this case, the device provides valuable real-time sensing information that can help to ensure that the implant is optimally fitted. This can be judged in terms of one or more of the following implant installation attributes:—primary stability, mechanical conformity, acoustic coupling to the bone, a reduced susceptability to premature loosening, and/or reduced risk of fracture or wear damage in the implant or contacting bone structure.

After implant installation, the device can also be used by the clinician to periodically inspect and assess the structural integrity of the implant-bone interface as the implant beds-in or fuses around the growing/living bone (i.e. the process known as osseointegration). This may also help the clinician to determine an optimal time to place the implant under mechanical loading.

For smaller non-prosthetic implants (e.g. dental or cochlear), the relative low cost of the device means that such non-destructive inspection can be extended to provide a level of more intensive or longer-term monitoring that could be conducted by the patient at home in order to detect the very earliest signs of any incipient mechanical or structural distress (e.g. dental implant interface degradation due to loading). This type of longer-term or more intensive home inspection or monitoring use of the device can also facilitate explicit clinical assessment of the surrounding bone and can indicate the onset of serious degenerative disease such as osteoporosis (i.e. via long-term trend analysis).

For larger implants such as artificial joints (e.g. hip, knee), the device can assist the clinician make a long-term assessment of the implant through either periodic inspections, automated in-service and/or online condition monitoring. In particular, the snap-through buckling actuators described herein are simple, compact and light-weight. This means they can be easily embedded within or across the surface of such implant structures so as to be activated directly by the clinician during a scheduled inspection to detect serious loss of structural integrity, micro-cracking, delamination or degradation in primary stability.

FIG. 28 illustrates a dental implant 700 in a patient's jaw 702. An acoustic device having a snap-through buckling actuator 704 may be triggered on the top of the implant 700. An acoustic receiver 706 attached to the skin of the patient may receive the ultrasound pulse emitted by the actuator 704. During installation, repeated trigger of the actuator 704 may be performed until an optimum implant fit is attained.

FIG. 29 shows an alternative arrangement to inspect an implant 720 in a patient's jaw 722. An acoustic receiver 724 is coupled to the implant 720. A mount 726 is provided to carry a snap-through buckling actuator 728. The action of the patient biting down on the mount 726 causes the snap-through buckling actuator 728 to trigger.

FIG. 30 illustrates how a plurality of snap-through buckling actuators 750 may be embedded within a replacement hip joint 752 (or any such joint). The actuation force can be either generated directly by relative movements within the human body or, as shown in FIG. 30, from an external source. In particular, a magnetic field may be applied from outside the body to induce the snap-through action inside the in-implant. The magnetic field may be generated using an induction coil 754 positioned near to the patients limb.

It should be noted that titanium alloy implants employed in many types of medical prosthetics (e.g. hip, knee or dental) are high-value complex geometry components that require extremely high-precision machining or are manufactured using additive manufacturing (AM) techniques. The snap-through buckling actuators may thus be integrated directly into metallic alloy implant designs at any location during the manufacturing stage without requiring subsequent attachment/retro-fitting to the implant structure after manufacture. In addition to reducing installation and manufacturing costs, such direct actuator integration increases the probing signal strength (i.e. improves SNR) across the implant and removes additional inspection waveform complexity or variability due to the absence of attenuation and mode conversion at the actuator-bulk implant interface. This improvement in the inspection signal (i.e. higher SNR with inherently lower variability) lends itself to more flexibility in the positioning and mounting of the receiving acoustic sensors, potentially reducing the number of receiving sensors or measurement positions required for adequate inspection and/or removes reliance upon liquid couplants. Energy harvesting methods may also be used in such medical implant applications.

In summary, the snap-through buckling actuator described herein may be incorporated, or built as part of, any structure. Low-frequency movement or vibration may be harvested (e.g. using one or more step-up frequency converters) to actuate the snap-through buckling actuator. The snap-through buckling actuator may thus be a structure-borne through-transmission acoustic source. The device may then be used in a wide range of condition monitoring or NDT applications. This may include some that work against a high acoustic noise background or where monitoring is required over long time-scales (e.g. a rail inspection system) or where a high voltage piezo ultrasonic source is less practical (e.g. in-vivo titanium implant integrity monitoring). As explained above, the snap-through buckling actuator is advantageous because it offers a high SNR and is a repeatable wideband modulated source that can be mechanically actuated without liquid couplant.

It should further be noted that although the above described methods employ a snap-through buckling actuator, the signal analysis methods described herein could be applied to analysing signals generated by different acoustic sources. For example, the signal analysis techniques could be used with conventional AE sources (e.g. Hsu-Neilsen Lead break sources or piezo driven actuators). In particular, it should be noted that the Delta-T location and TDOA techniques described herein could advantageously be used with any acoustic source.

It is also important to remember that the above described examples are non-limiting and are merely provided to aid understanding of the present invention.

Although several CMM based examples are outlined above, any suitable the type of automation platform may be employed. For example, a robotic arm or comparator gauging machine may be used. Any of the handheld arrangement may be implemented on an automated platform, or vice versa.

It should also be noted that many different designs and configurations of snap-through buckling actuators are envisaged. For example, FIGS. 31(a) and 31(b) show variants of the domed snap-through buckling actuation described above. FIG. 31(a) shows a folded metal sheet with slits and FIG. 31(b) shows a domed structure with slits. Bi-stable and/or multi-stable versions of the snap-through buckling actuator may also be provided. Further to the single mono-stable plate design of snap-through buckling actuator outlined above, various other designs could be employed. For example, a snap-through buckling actuator may be formed having more than one snap-through buckling plate. Such an actuator could include a plurality of buckling plates attached radially to a central hub like the spokes of a wheel. This would allow an automation platform to move quickly over the inspection surface retaining a constant loading force so as to generate a high granularity regular pattern of discrete spatially separated actuations as it rolls over the inspection surface. The skilled person would, on reading the above, be aware of the various modifications and alternative designs that would be possible.

1. An acoustic device for inspecting an object, the device comprising an ultrasonic source comprising a snap-through buckling actuator for generating ultrasound for coupling into the object to be inspected.

2. A device according to claim 1, comprising at least one tip for contacting the object to be inspected.

3. A device according to claim 2, comprising a waveguide for guiding energy released by the snap-through buckling actuator to said at least one tip.

4. A device according to claim 1, wherein the snap-through buckling actuator comprises an elastically deformable, flexible beam that includes one or more features that provide a snap-through buckling action when subjected to a mechanical load.

5. A device according to claim 4, wherein the flexible beam comprises a thin metallic plate.

6. A device according to claim 4, wherein the elastically deformable, flexible beam is monostable and returns to its stable state when the mechanical load is removed.

7. A device according to claim 4, wherein one end of the elastically deformable, flexible beam is secured to a rigid base member.

8. An acoustic inspection apparatus, comprising a device according to claim 1 and at least one acoustic receiver for attachment to the object to be inspected, the at least one acoustic receiver being arranged to receive ultrasound that has passed through the object from the ultrasonic source.

9. An acoustic inspection apparatus according to claim 8, comprising a plurality of acoustic receivers.

10. An acoustic inspection apparatus according to claim 8, comprising a signal analyser unit for receiving and analysing one or more signals received by the at least one acoustic receiver.

11. An acoustic inspection apparatus according to claim 10, wherein the signal analyser unit is arranged to perform a time of difference arrival (TDOA) analysis.

12. An acoustic inspection apparatus according to claim 9, comprising an automated positioning platform, the automated positioning platform being arranged to move the ultrasonic source relative to the object such that the ultrasonic source can be moved into engagement with one or more points on the surface of the object.

13. An acoustic inspection apparatus according to claim 9, wherein the acoustic source is incorporated in a handheld unit.

14. An object having a device according to claim 1 incorporated therein, the snap-through buckling actuator of the device being arranged to generate an ultrasound pulse for propagation through the object.

15. A method for acoustically inspecting an object using an ultrasound pulse, comprising the steps of using a snap-through buckling actuator to generate the ultrasound pulse and coupling the ultrasound pulse into the object.
